(19) United States
(12) Patent Application Publication
(10) Pub. No.: US 2008/0218515 A1
(43) Pub. Date: Sep. 11, 2008

(54) THREE-DIMENSIONAL-IMAGE DISPLAY SYSTEM AND DISPLAYING METHOD

(76) Inventors: Rieko Fukushima, Tokyo (JP); Kaoru Sugita, Saitama (JP); Akira Morishita, Tokyo (JP); Yuzo Hirayama, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/043,255

(22) Filed: Mar. 6, 2008

(30) Foreign Application Priority Data
Mar. 7, 2007 (JP) 2007-057423

(51) Int. Cl. G06T 17/00

(52) U.S. Cl. 345/424

(57) ABSTRACT

A three-dimensional-image display system generates a first physical-calculation model generator that expresses a real object, based on both position/posture information expressing a position and posture of the real object, and attribute information expressing attribute of the real object. The three-dimensional-image display system displays a three-dimensional image within a display space, based on a calculation result of the interaction between the first physical-calculation model and a second physical-calculation model expressing a virtual external environment of the real object within the display space.

### CROSS-REFERENCE TO RELATED APPLICATIONS

This application is based upon and claims the benefit of priority from the prior Japanese Patent Application No. 2007-057423, filed on Mar. 7, 2007; the entire contents of which are incorporated herein by reference.

### BACKGROUND OF THE INVENTION

1. Field of the Invention

The present invention relates to a three-dimensional-image display system and a displaying method that generates a three-dimensional image in conjunction with a real object.

2. Description of the Related Art

Conventionally, techniques called mixed reality (MR) and augmented reality (AR) that are combinations of a two-dimensional image or a three-dimensional image with a real object have been known. These techniques are disclosed in, for example, JP-A 2000-350860 (KOKAI) and “Tangible Bits: User Interface Design towards Seamless Integration of Digital and Physical Worlds” by ISHII, Hiroshi, IPSJ Magazine, Vol. 43, No. 3, pp. 222-229, 2002. There has also been proposed an interface device that causes a real object located on a display surface to interact with a real object, by directly operating a two-dimensional image or a three-dimensional image displayed in superposition with real space, by hand or with the real object grasped in hand, based on these techniques. This interface device employs a head-mount display system that directly displays an image before the eyes, or a projector system that projects a three-dimensional image to real space, to display the image. Because the image is displayed in front of an observer in real space, the image is not disturbed by the real object or the operator's hand.

On the other hand, a naked-eye three-dimensional viewing system involving motion parallax is proposed, including an IP system and a dense multi-view system, to obtain a three-dimensional image that is natural and easy to look at (hereinafter, “space image system”). In this space image system, motion parallax can be achieved by displaying an image picked up from three or more view points, ideally from nine or more view points, by changing over between observation positions in space, based on a combination of a flat display (FDP) as represented by a liquid crystal display (LCD) having many pixels and a ray control element such as a lens array and a pinhole array. Unlike a conventional three-dimensional image formed using only convergence, a three-dimensional image displayed by adding motion parallax which can be observed with naked eyes has coordinates in real space independently of the observation position. Accordingly, a problem of a three-dimensional image that sense of discomfort when the image and the real object interfere with each other can be removed. The observer can point out the three-dimensional image or can simultaneously view the real object and the three-dimensional image.

However, the MR or the AR that combines a two-dimensional image with a real object has a constraint that a region in which the interaction can be expressed is limited to the display surface. According to the MR or the AR that combines a two-dimensional image with a real object, view-point adjustment fixed to the display surface competes with the convergence induced from the binocular disparity. Therefore, simultaneous viewing of the real object and the three-dimensional image gives the observer sense of discomfort and fatigue. Consequently, the interaction between the image and the real space or the real object produces an incomplete state of expression and amalgamation, and it is difficult to express live feeling or sense of reality.

Further, according to the space image system, resolution of a displayed three-dimensional image decreases to 1/(number of view points) of the resolution of the flat display (FPD). Because the resolution of the FPD has an upper limit due to a constraint of drive and the like, it is not easy to increase the resolution of the three-dimensional image, and improving the live feeling or sense of reality becomes difficult. Further, according to the space image system, the flat display is laid out at the back of the hand or the real object held in hand to operate the image. Therefore, the three-dimensional image is shielded by the operator hand or the real object, and this interferes with the natural amalgamation between the real object and the three-dimensional image.

### SUMMARY OF THE INVENTION

According to one aspect of the present invention, a three-dimensional-image display system includes a display that displays a three-dimensional image within a display space according to a space image mode; and a real object having at least a part of which laid out in the display space is a transparent portion, wherein the display includes: a position/posture-information storage unit that stores position posture information expressing a position and posture of the real object; an attribute-information storage unit that stores attribute information expressing attribute of the real object; a first physical-calculation model generator that generates a first physical-calculation model expressing the real object, based on the position/posture information and the attribute information; a second physical-calculation model generator that generates a second physical-calculation model expressing a virtual external environment of the real object within the display space; a calculator that calculates interaction between the first physical-calculation model and the second physical-calculation model; and a display controller that controls the display for displaying a three-dimensional image within the display space, based on the interaction.

According to another aspect of the present invention, there is provided a method for displaying to a system having a display and a real object including storing position posture information expressing a position and posture of the real object to a storage unit; storing attribute information expressing attribute of the real object to the storage unit; generating a first physical-calculation model expressing the real object, based on the position/posture information and the attribute information; generating a second physical-calculation model expressing a virtual external environment of the real object within a display space; calculating interaction between the first physical-calculation model and the second physical-calculation model; and controlling the display for displaying a three-dimensional image within the display space, based on the interaction, wherein the display displays the three-dimensional image within the display space according to a space image mode, the real object having at least a part of which laid out in the display space is a transparent portion.

### BRIEF DESCRIPTION OF THE DRAWINGS

FIG. 1 is a block diagram of a hardware configuration of a three-dimensional-image display apparatus according to a first embodiment of the present invention;

FIG. 2 is a schematic perspective view of a configuration of a three-dimensional-image display unit;

FIG. 3 is a schematic diagram for explaining a multi-view three-dimensional-image display unit;

FIG. 4 is a schematic diagram for explaining a three-dimensional-image display unit with a one-dimensional IP-system;

FIG. 5 is a schematic diagram of a state that a parallax image changes;

FIG. 6 is another schematic diagram of a state that the parallax image changes;

FIG. 7 is a block diagram of one example of a functional configuration of the three-dimensional-image display apparatus;

FIGS. 8 to 13B are display examples of a three-dimensional image;

FIG. 14 is a block diagram of one example of a functional configuration of a three-dimensional-image display apparatus according to a second embodiment of the present invention;

FIGS. 15 to 18 are display examples of a three-dimensional image;

FIG. 19 is a block diagram of one example of a functional configuration of a three-dimensional-image display apparatus according to a third embodiment of the present invention;

FIG. 20 is a block diagram of one example of a functional configuration of a three-dimensional-image display apparatus according to a fourth embodiment of the present invention;

FIG. 21 is a display example of a three-dimensional image;

FIG. 22A is a configuration of a real object;

FIG. 22B is a display example of a three-dimensional image;

FIG. 23 is a block diagram of one example of a functional configuration of a three-dimensional-image display apparatus according to a fifth embodiment of the present invention;

FIGS. 24 to 26 are display examples of a three-dimensional image;

FIGS. 27A to 27C are examples of a position/posture detecting method of a real object;

FIG. 28 is a block diagram of one example of a functional configuration of a three-dimensional-image display apparatus according to a modification of the fifth embodiment of the present invention;

FIGS. 29A to 29B are examples of a position/posture detecting method of a real object;

FIG. 30 is a block diagram of one example of a functional configuration of a three-dimensional-image display apparatus according to a sixth embodiment of the present invention;

FIGS. 31A to 33 are examples of a position/posture detecting method of a real object;

FIG. 34 is a block diagram of one example of a functional configuration of a three-dimensional-image display apparatus according to a seventh embodiment of the present invention; and

FIG. 35 is another block diagram of one example of a functional configuration of the three-dimensional-image display apparatus.

### DETAILED DESCRIPTION OF THE INVENTION

Exemplary embodiments of the present invention will be explained below in detail with reference to the accompanying drawings.

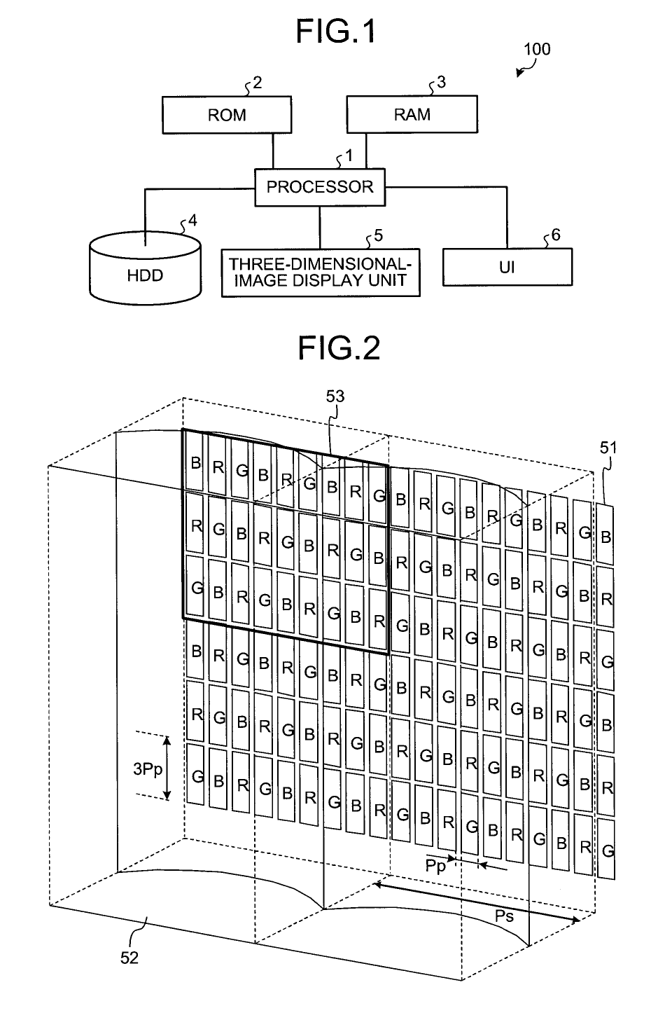

FIG. 1 is a block diagram of a hardware configuration of a three-dimensional-image display apparatus 100 according to a first embodiment of the present invention. The three-dimensional-image display apparatus 100 includes a processor 1 such as a central processing unit (CPU), a graphics processing unit (GPU), a digital signal processor (DSP), a numeric coprocessor, and a physical calculation processor, a read only memory (ROM) 2 that stores BIOS, a random access memory (RAM) 3 that rewritably stores various kinds of data, a hard disk drive (HDD) 4 that stores various kinds of contents concerning a display of a three-dimensional image and stores a three-dimensional-image display program concerning a display of a three-dimensional image, a three-dimensional-image display unit 5 of a space image system such as an integral imaging (II) system that outputs and displays a three-dimensional image, and a user interface (UI) 6 through which a user inputs various kinds of instructions to a main device and displays various kinds of information in the main device. Each of three-dimensional-image display apparatuses 101 to 106 described later also includes a hardware configuration similar to that of the three-dimensional-image display apparatus 100.

The processor 1 of the three-dimensional-image display apparatus 100 controls each unit by executing various kinds of processing following the three-dimensional-image display program.

The HDD 4 stores real-object position/posture information and real-object attribute information described later, as various kinds of contents concerning a display of a three-dimensional image, and various kinds of information that becomes a basis of a physical operation model (Model_other 132) described later.

The three-dimensional-image display unit 5 displays a three-dimensional image of a space image system including an optical element having exit pupils arrayed in a matrix shape on the flat panel display represented by liquid crystal and the like. This display device makes the three-dimensional image of the space image system visible to the observer, by changing over between pixels that can be viewed through the exit pupils according to an observation position.

A structuring method of an image displayed on the three-dimensional-image display unit 5 is explained below. The three-dimensional-image display unit 5 of the three-dimensional-image display apparatus 100 according to the first embodiment is designed to be able to reproduce rays of n parallaxes. In the first embodiment, explanations are given assuming that the parallax number n=9.

FIG. 2 is a schematic perspective view of a configuration of the three-dimensional-image display unit 5. In the three-dimensional-image display unit 5, a lenticular sheet including a cylindrical lens, with an optical aperture extended in a vertical direction, as a ray control element, is laid out on the front surface of the display surface of a flat parallax-image display unit 51 such as a liquid crystal panel, as shown in FIG. 2. The optical aperture is a vertical straight line instead of an inclined or staged optical aperture. Therefore, the pixel layout at the three-dimensional display time can be easily set to a square layout.

On the display surface, pixels 201, each having an aspect ratio of 3 to 1, are laid out in a straight line in a lateral direction, with red (R), green (G), and blue (B) laid out alternately in the lateral direction in the same row. A vertical cycle (3Pp) of the pixel row is three times a lateral cycle Pp of the pixels.

In a color-image display device that displays color images, three pixels of R, G, B constitute one effective pixel. That is, these three pixels constitute a minimum unit that can optionally set brightness and color. Each of R, G, B is generally called a sub-pixel.

In the display screen shown in FIG. 2, pixels of nine columns and three row constitute one effective pixel 53 (a part encircled by a black frame). The cylindrical lens of the lenticular sheet as a ray control element 52 is laid out substantially in front of the effective pixel 53.

In the parallel-ray one-dimensional IP system, the lenticular sheet, as the ray control element 52 in which each cylindrical lens extends linearly as a horizontal pitch (Ps) equivalent to nine times the lateral cycle (Pp) of sub-pixels laid out within the display surface, reproduces rays from pixels at every nine pixels, as parallel rays horizontally on the display surface.

To set the actually assumed view points at a finite distance from the display surface, each parallax component image, having the integration of image data of pixels of a set constituting a parallel ray in the same parallax direction necessary to constitute the image of the three-dimensional-image display unit 5, is larger than nine. A parallax composite image to be displayed in the three-dimensional-image display unit 5 is generated by extracting rays actually used from this parallax component image.

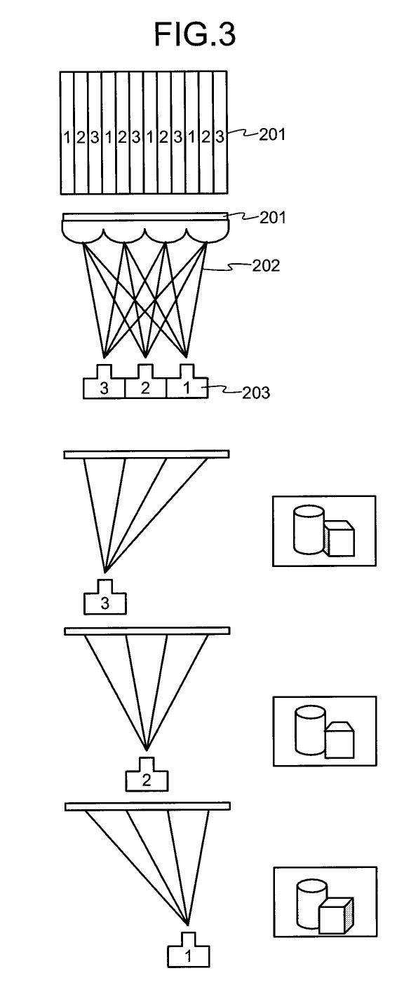

FIG. 3 is a schematic diagram of one example of a relationship between each parallax component image in the multi-view three-dimensional-image display unit 5 and the parallax component image on the display screen. Reference numeral 201 denotes an image for a three-dimensional image display, 203 denotes an image acquisition position, and 202 denotes a line connecting between the center of the parallax image and an exit pupil at the image acquisition position.

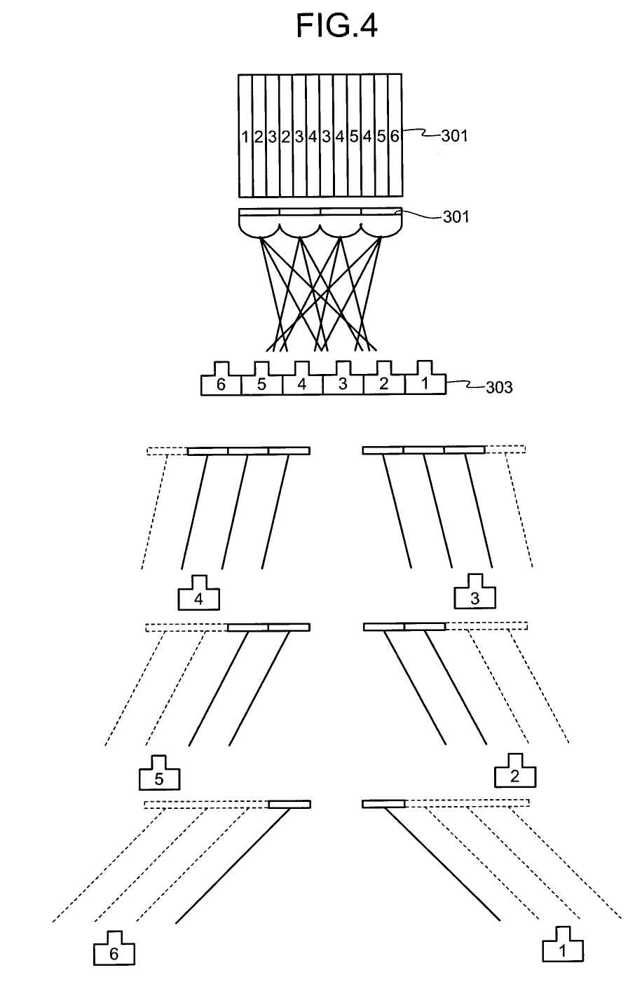

FIG. 4 is a schematic diagram of one example of a relationship between each parallax component image in the three-dimensional-image display unit 5 with a one-dimensional IP-system and the parallax component image on the display screen. Reference numeral 301 denotes an image for a three-dimensional image display, 303 denotes an image acquisition position, and 302 denotes a line connecting between the center of the parallax image and an exit pupil at the image acquisition position.

In the three-dimensional display with a one-dimensional IP-system, plural cameras of a number larger than that of the set parallaxes of three-dimensional display laid out at a specific view distance from the display surface acquire images (performs rendering in the computer graphics). Rays necessary for a three-dimensional display are extracted from the rendered images, and are displayed. The number of rays extracted from each parallax component image is determined based a size of the display surface of the three-dimensional display, resolution, and the assumed view distance.

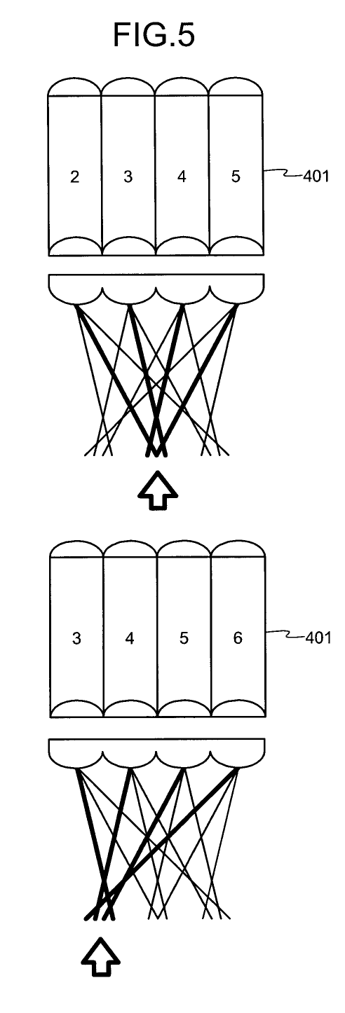

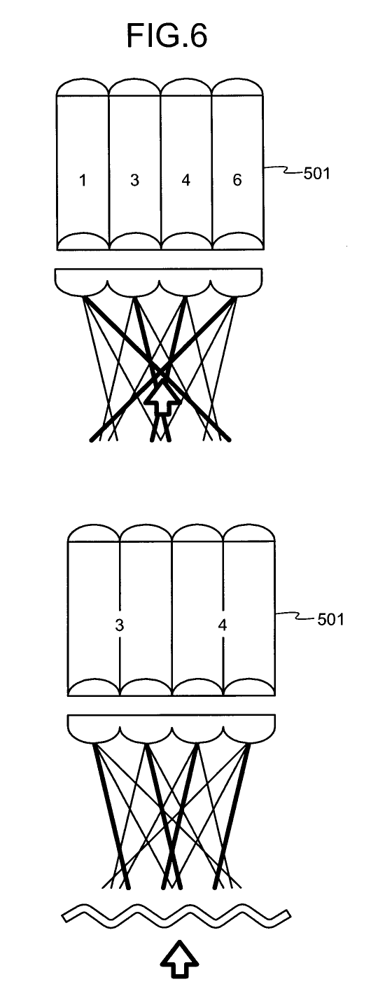

FIG. 5 and FIG. 6 are schematic diagrams of a state that a parallax image visible from the user changes when a view distance changes. In FIGS. 5 and 6, reference numerals 401 and 501 denote numbers of parallax images recognized at the observation positions. As shown in FIGS. 5 and 6, it is understood that a parallax image visible at the observation position is different when the view distance changes.

In each parallax component image, a perspective projection corresponding to the assumed view distance or its near view distance is obtained in a vertical direction, and a parallel projection is obtained in the horizontal direction, as a standard. However, it can be arranged such that perspective projection is obtained in both the vertical direction and the horizontal direction. That is, a necessary and sufficient number of cameras can be used to pick up images or draw images, when generation of an image in the three-dimensional display device concerning the ray regeneration system can be converted to ray information to be regenerated.

The three-dimensional-image display unit 5 according to the embodiment is explained below based on the assumption that positions and the number of cameras that can obtain rays necessary and sufficient to display a three-dimensional image are calculated.

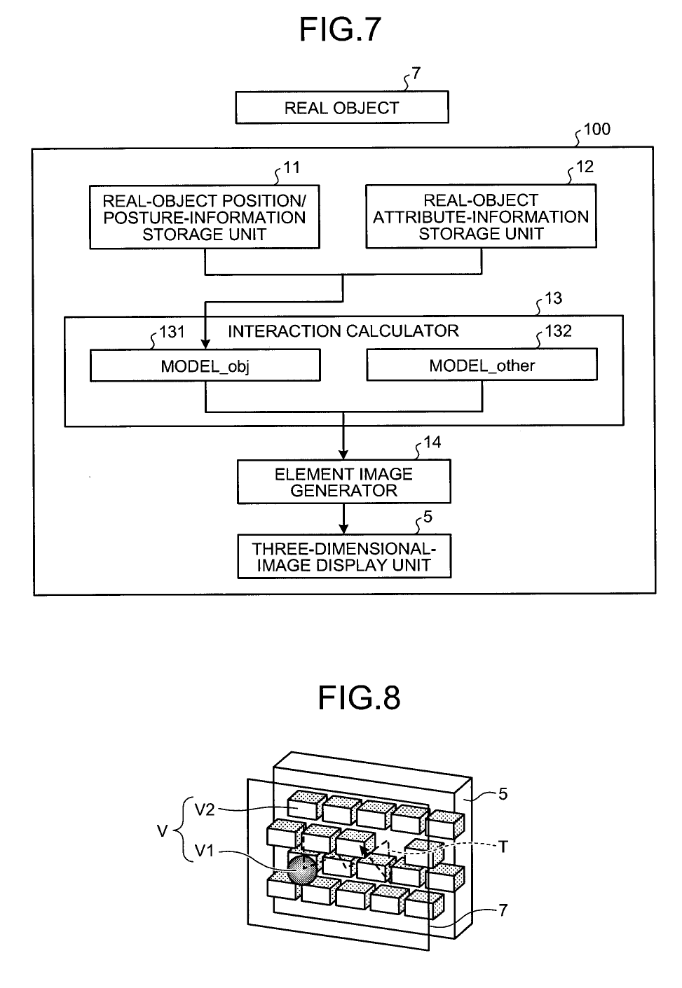

FIG. 7 is a block diagram of a functional configuration of the three-dimensional-image display apparatus 100 according to the first embodiment. As shown in FIG. 7, the three-dimensional-image display apparatus 100 includes a real-object position/posture-information storage unit 11, a real-object attribute-information storage unit 12, an interaction calculator 13, and an element image generator 14 that are provided based on the control performed by the processor 1 following the three-dimensional-image display program.

The real-object position/posture-information storage unit 11 stores information concerning a position and posture of a real object 7 laid out within space (hereinafter, display space) that can be three-dimensionally displayed by the three-dimensional-image display unit 5, as real-object position/posture information, in the HDD 4. The real object 7 is a real entity at least a part of which is made of a transparent member. For example, a transparent acrylic sheet or a glass sheet can be used for the real object. A shape and a material of the real object 7 are not particularly concerned.

The real-object position/posture information includes position information expressing the current position of the real object in the three-dimensional-image display unit 5, and motion information expressing a position and a move amount from a certain point of time in the past to the current time, and a speed, and posture information expressing the current and past postures (directions, etc.) of the real object 7. In the case of an example described later with reference to FIG. 8, a distance from the center of the thickness of the real object 7 to the display surface of the three-dimensional-image display unit 5 is stored as real-object attribute information.

The real-object attribute-information storage unit 12 stores specific attributes of the real object 7 itself, as real-object attribute information, in the HDD 4. The real-object attribute information includes shape information (polygon information, numerical expression information (such as NURBS) expressing a shape) expressing the shape of the real object 7, and physical characteristic information (optical characteristics of the surface of the real object 7, material, strength, thickness, refractive index, etc.) expressing physical characteristics of the real object 7. For example, in the case of an example explained later with reference to FIG. 8, optical characteristics and thickness of the real object 7 are stored as real-object attribute information.

The interaction calculator 13 generates a physical calculation model (Model_obj) expressing the real object 7, from the real-object position/posture information and the real-object attribute information stored in the real-object position/posture-information storage unit 11 and the real-object attribute-information storage unit 12, respectively. The interaction calculator 13 also generates a physical calculation model (Model_other) expressing a virtual external environment within the display space of the real object 7, based on the information stored in advance in the HDD 4, and calculates interaction between Model_obj and Model_other. Pieces of various kinds of information that become the basis of generating Model_other are stored in advance in the HDD 4, and are read out when necessary by the interaction calculator 13.

Model_obj is information expressing the whole or a part of the characteristics of the real object 7 in the display space, based on the real-object position/posture information and the real-object attribute information. It is assumed that, in the example explained later with reference to FIG. 8, a distance from the center of the thickness of the real object 7 to the display surface of the three-dimensional-image display unit 5 is “a”, and the thickness of the real object 7 is “b”. A vertical direction of the display surface of the three-dimensional-image display unit 5 is assumed as the Z axis. The interaction calculator 13 then generates the following relational expression (1) or a calculation result of the expression (1), as Model_obj expressing a surface position (Z1) at the three-dimensional-image display unit 5 side of the real object 7.

Z1=a−b (1)

While Model_obj 131 is explained to express conditions concerning the surface of the real object 7, Model_obj 131 can also express conditions representing the refractive index and strength, and can express behavior in a predetermined condition (for example, a reaction when another virtual object collides against the virtual object corresponding to the real object 7).

Model_other is the information including position information, motion information, shape information, and physical characteristic information of a three-dimensional image (virtual object) displayed in the virtual space, and expressing characteristics of the virtual external environment in the display space other than Model_obj such as the behavior of the virtual object 7 in a predetermined condition, like a change of the shape of the virtual object by a predetermined amount at a collision time. Calculation is performed so that the behavior of the virtual object follows the actual laws of nature such as a motion equation. When the behavior of the virtual object V can be displayed without a feeling of strangeness unlike the behavior in the actual world, the behavior can be calculated using a simple relational expression, instead of strictly following the laws of nature.

It is assumed that in the example described later with reference to FIG. 8, a radius of a spherical virtual object V1 is “r”, and a center position of the virtual object V1 on the Z axis is “c”. In this case, the interaction calculator 13 generates the following relational expression (2) or a calculation result of this expression (2) as Model_other that expresses a surface position (Z2) of the virtual object V1 on the Z axis at the real object 7 side.

Z2=c+r (2)

To calculate the interaction between Model_obj and Model_other means to derive a state change of Model_other in the condition of Model_obj, based on a predetermined determination standard, using the generated Model_obj and Model_other.

For instance, in the example described later with reference to FIG. 8, in determining a virtual collision between the real object 7 and the spherical virtual object V1, the interaction calculator 13 derives the following expression (3) from the expressions (1) and (2), using Model_obj expressing the real object 7 and Model_other expressing the virtual object V1, and determines whether the real object 7 and the virtual object V1 collided against each other, based on the calculation result.

Collision determination=(a−b)−(c+r) (3)

In the above example, the interaction between Model_obj 131 and Model_other 132 is explained as the collision of the virtual object expressed by both physical calculation models, that is, a mode of determining only a condition concerning the surface of the virtual object. However, the interaction is not limited thereto, and can be a mode of determining another condition.

When the value of the expression (3) is zero (or smaller than zero), the interaction calculator 13 determines that the real object 7 and the virtual object V1 collide against each other, calculates a change of the shape of the virtual object V1, and changes Model_other to express that a motion track of the virtual object V1 has bounded. As explained above, in the interaction calculation, Model_other is changed as a result of taking in Model_obj.

The element image generator 14 generates multi-viewpoint images by rendering, reflecting a calculation result of the interaction calculator 13 to at least one of Model_obj 131 and Model_other 132, and generates the element image array by rearranging the multi-viewpoint images. The element image generator 14 displays the generated element image array in the display space of the three-dimensional-image display unit 5, thereby performing a three-dimensional display of the virtual object.

A three-dimensional image displayed in the three-dimensional-image display unit 5 based on the above configuration is explained below. FIG. 8 depicts a state that a spherical virtual object V1 and block-shaped virtual objects V2 are displayed between the three-dimensional-image display unit 5 set vertically and the transparent real object 7 set vertically near the position parallel with the three-dimensional-image display unit 5. A dotted line T in FIG. 8 expresses a motion track of the spherical virtual object V1.

In the example shown in FIG. 8, information indicating that the real object 7 is set in parallel with the display surface of the three-dimensional-image display unit 5 at a position with a distance of 10 centimeters from the display surface is stored in the real-object position/posture-information storage unit 11 as the real-object position/posture information. The real-object attribute-information storage unit 12 stores attributes specific to the real object 7, such as a material, a shape, thickness, strength, and refractive index of an acrylic sheet or a glass sheet, are stored as the real-object attribute information.

The interaction calculator 13 generates Model_obj expressing the real object 7, generates Model_other expressing the virtual objects V (V1, V2), based on the real-object position/posture information and the real-object attribute information, and calculates interaction between both physical calculation models.

In the example shown in FIG. 8, a collision between the real object 7 and the virtual object V1 can be taken as a determination standard at the interaction time. In this case, the interaction calculator 13 can obtain a calculation result that the spherical virtual object V1 bounces to the real object 7, as a result of the interaction between Model_obj and Model_other. The interaction between the virtual object V1 and the virtual object V2 can be also calculated similarly. For example, a calculation result of the interaction that the virtual object V1 breaks the virtual object V2 can be obtained, in the condition that the virtual object V1 bounces from the real object 7 and collides against the block-shaped virtual object V2.

The element image generator 14 generates a multi-viewpoint image taking into account the calculation result of the interaction calculator 13, and converts the multi-viewpoint image into an element image array to be displayed in the three-dimensional-image display unit 5. As a result, the virtual object V is three-dimensionally displayed in the display space of the three-dimensional-image display unit 5. The virtual object V generated and displayed in this process is observed simultaneously with the transparent real object 7. Accordingly, the observer can observe a state that the spherical virtual object V1 collides against the transparent real object 7, or the virtual object V1 collides against the block-shaped virtual object V2, and the virtual object V2 collapses. These virtual reactions can remarkably improve the sense of presence of the three-dimensional image in short of resolution, and can achieve unconventional live feeling.

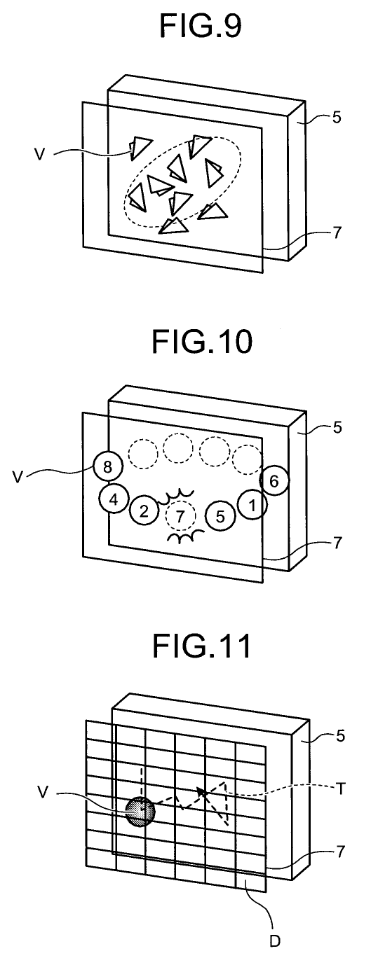

While spherical and block-shaped virtual objects V are handled in FIG. 8, their modes are not limited to those shown in FIG. 8. For example, sheets of paper (see FIG. 9) or bubble (see FIG. 10) can be displayed as the virtual objects V between the transparent object 7 and the three-dimensional-image display unit 5. These virtual objects V can be flown up with virtually generated convection, or can be collided against the real object 7 and broken. In this way, interaction can be calculated in a predetermined condition.

As shown in FIG. 8 to FIG. 10, when the whole surface of the three-dimensional-image display unit 5 is covered with the real object 7 having relatively high translucency such as a glass sheet, the real object 7 itself is not easily visible. Therefore, a relative positional relationship with the virtual object V is made easily visually recognized, by drawing a certain figure or a pattern on the real object 7.

FIG. 11 depicts a state that a lattice pattern is provided as a pattern D on the surface of the real object 7. A dotted line T in FIG. 11 expresses a motion track of the spherical virtual object V. The pattern D can be actually drawn on the real object 7 or can be expressed by pasting a seal material to the real object 7. For example, a scattering region that scatters light inside the real object 7 is provided, and the end surface of the real object 7 is illuminated with a light source such as a light-emitting diode (LED), thereby generating scattering beam at the scattering position. In this case, illumination light to regenerate the virtual object V can be irradiated to the end surface of the real object 7, thereby generating scattering beam. Alternatively, brightness of light irradiating the end surface of the real object 7 can be modulated, according to the motion of the virtual object V.

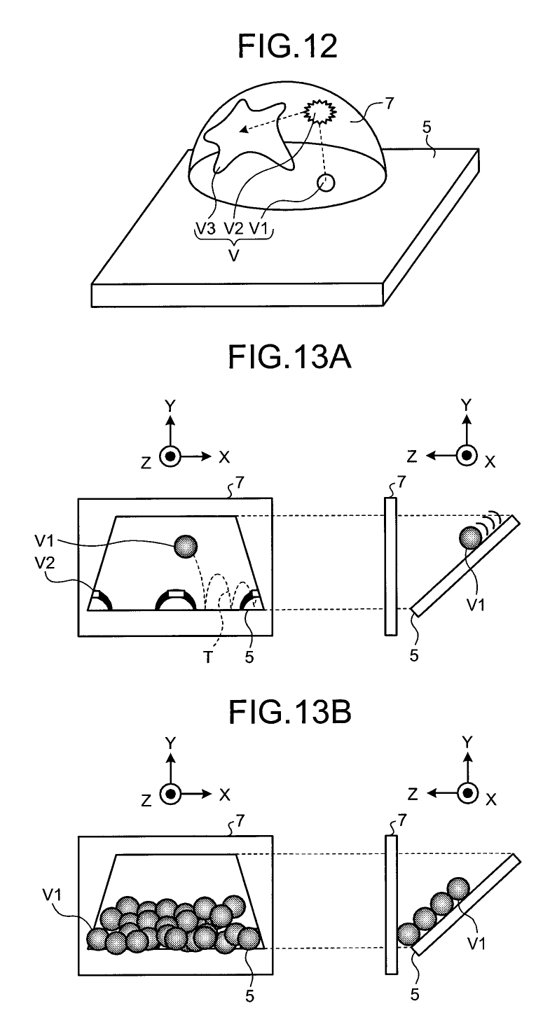

The configurations of the three-dimensional-image display unit 5 and the real object 7 are not limited to the examples described above, and can be other modes. Other configurations of the three-dimensional-image display unit 5 and the real object 7 are explained below with reference to FIG. 12, and FIGS. 13A and 13B.

FIG. 12 depicts a configuration that the transparent hemispherical real object 7 is mounted on the three-dimensional-image display unit 5 installed horizontally. Virtual objects V (V1, V2, V3) are displayed within the hemisphere of the real object 7. The dotted line T in FIG. 12 expresses the motion track of the virtual objects V (V1, V2, V3).

In the configuration shown in FIG. 12, the real-object position/posture-information storage unit 11 stores information for instructing that the real object 7 is mounted at a specific position on the display surface of the three-dimensional-image display unit 5 so that a great-circle side of the hemisphere is in contact with the three-dimensional-image display unit 5. The real-object attribute-information storage unit 12 stores specific attributes of the real object 7, such as a material of an acrylic sheet and a glass sheet, a shape, strength, thickness, and refractive index of a hemisphere having a radius of 10 centimeters, as real-object attribute information.

The interaction calculator 13 generates Model_obj 131 expressing the real object 7, and generates Model_other 132 expressing the virtual objects V (V1, V2, V3) other than Model_obj 131, based on the real-object position/posture information and real-object attribute information, and calculates the interaction between both physical calculation models.

In the example shown in FIG. 12, a collision between the real object 7 and the virtual object V1 can be taken as a determination standard at the interaction time. In this case, the interaction calculator 13 can express a phenomenon that the virtual object V1 bounces to the real object 7, as a result of the interaction between Model_obj 131 expressing the real object 7 and Model_other 132 expressing the virtual object V. The interaction calculator 13 can also display the virtual object (V2) of expressing a spark identifying bouncing to the collision position, or can express a phenomenon of displaying the virtual object (V3) representing a virtual content along a curved surface of the real object 7, by exploding the virtual object V1.

The element image generator 14 generates a multi-viewpoint image by rendering, after reflecting the calculation result of the interaction calculator 13 to at least one of Model_obj 131 and Model_other 132, and generates the element image array by rearranging the multi-viewpoint images. The element image generator 14 displays the generated element image array in the display space of the three-dimensional-image display unit 5.

By simultaneously observing both the virtual object V generated and displayed in the above process and the transparent real object 7, the observer can view a state that the spherical virtual object V1 bounces or explodes by scattering sparks within the hemisphere of the real object 7.

FIG. 13A and FIG. 13B depict a state that the real object 7 made of a transparent sheet is vertically set near the lower end of the three-dimensional-image display unit 5 installed with a slope of 45 degrees from the horizontal surface.

The left parts of FIGS. 13A and 13B are front views of the real object 7 observed from the front direction (Z axis direction), and the right parts in FIGS. 13A and 13B are right side views of the real object 7. The three-dimensional-image display apparatus 100 displays the spherical virtual object V1 between the real object 7 and the three-dimensional-image display unit 5, and displays the hole-shaped virtual objects V2 on the display surface of the three-dimensional-image display unit 5. The dotted line T in FIG. 13A expresses the motion track of the virtual object V1.

In the configurations in FIGS. 13A and 13B, the real-object position/posture-information storage unit 11 stores information for instructing that the real object 7 is installed to form an angle of 45 degrees from the lower part of the display surface of the three-dimensional-image display unit 5. The real-object attribute-information storage unit 12 stores specific attributes of the real object 7, such as a material, a shape, strength, thickness, and refractive index of an acrylic sheet and a glass sheet, as real-object attribute information, like in the example described above.

The interaction calculator 13 generates Model_obj 131 expressing the real object 7, and generates Model_other expressing the virtual objects V (V1, V2), based on the real-object position/posture information and real-object attribute information, and calculates the interaction between both physical calculation models.

In the example shown in FIG. 13A, a collision between the real object 7 and the virtual object V1 can be taken as a determination standard at the interaction time. In this case, the interaction calculator 13 can obtain a calculation result that the virtual object V1 bounces to the real object 7, as a result of the interaction between Model_obj and Model_other. A contact between the virtual object V1 and the virtual object V2 can be also taken as another determination standard at the interaction time. In this case, as a result of the interaction between the virtual object V1 and the virtual object V2, a calculation result that the virtual object V1 falls into the hole-shaped virtual object V2 can be obtained.

In the example shown in FIG. 13B, a collision between the real object 7 and plural virtual objects V1 is taken as another determination standard at the interaction time. In this case, the interaction calculator 13 can obtain a calculation result that the plural virtual objects V1 stay in the valley between the real object 7 and the three-dimensional-image display unit 5, as a result of the interaction between Model_obj 131 and Model_other 132 expressing the plural virtual objects V1.

The element image generator 14 generates a multi-viewpoint image by rendering, after reflecting the calculation result of the interaction calculator 13 to at least one of Model_obj 131 and Model_other 132, and generates the element image array by rearranging the multi-viewpoint images. The element image generator 14 three-dimensionally displays the virtual object V, by displaying the generated element image array in the display space of the three-dimensional-image display unit 5.

By simultaneously observing the virtual objects V (V1, V2) generated and displayed in the above process, the observer can view a state that the spherical virtual object V1 bounces or is stopped, by using the flat-shaped real object 7.

In the example of the configuration shown in FIG. 13A, there can be provided a mechanism of making a real sphere (ball) corresponding to the virtual object V1 appear from the position corresponding to the virtual object V2 (the back surface of the three-dimensional-image display unit 5, for example) when the virtual object V1 falls into the hole-shaped virtual object V2. Accordingly, this can increase sense of presence of the virtual object V1, and improve interactiveness.

Specifically, the three-dimensional-image display apparatus 100 having the configuration shown in FIG. 13A is installed in a game machine or the like, and a ball of the virtual object V1 has attribute visually similar to that of a game ball. When the game ball is discharged from a discharge opening simultaneously with the timing that the ball of the virtual object V1 comes not to be displayed in the display space of the three-dimensional-image display unit 5, this operation can increase sense of presence of the virtual object V1 and improve live feeling.

As explained above, according to the first embodiment, interaction between the real object 7, having a transparent portion in at least a part thereof, laid out in the display space, and the virtual external environment of the real object 7 within the display space, is calculated. A calculation result can be displayed as a three-dimensional image (virtual object). Therefore, a natural amalgamation between the three-dimensional image and the real object can be achieved, and this can improve live feeling and sense of presence of the three-dimensional image.

A three-dimensional-image display apparatus according to a second embodiment of the present invention is explained next. Constituent elements similar to those in the first embodiment are denoted by like reference numerals, and explanations thereof will be omitted.

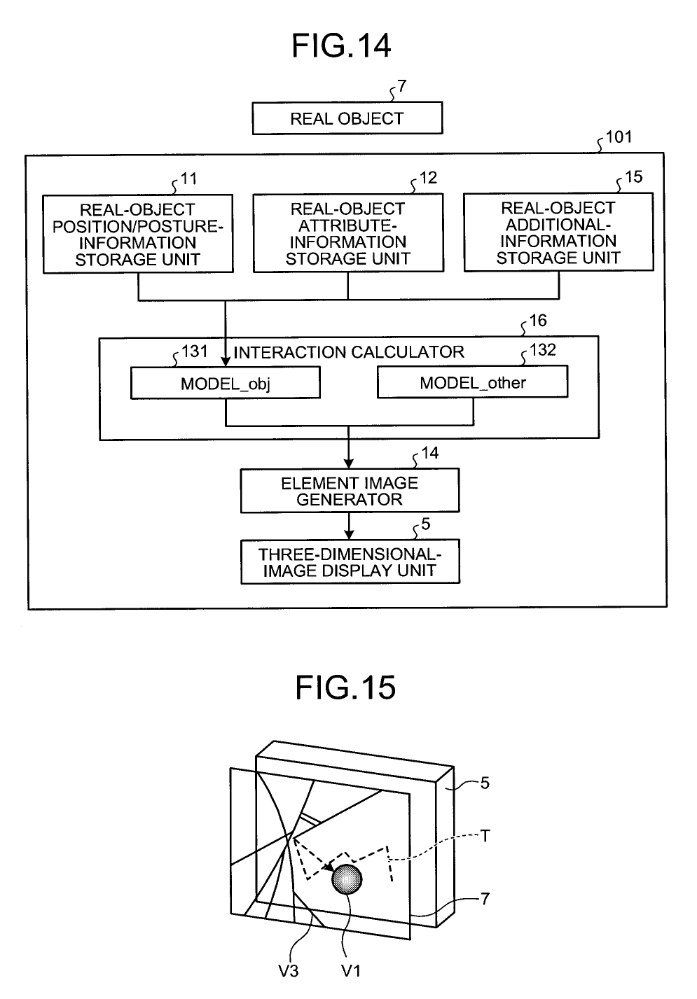

FIG. 14 is a block diagram of a functional configuration of the three-dimensional-image display apparatus 100 according to the second embodiment. As shown in FIG. 14, the three-dimensional-image display apparatus 101 includes the real-object position/posture-information storage unit 11, the real-object attribute-information storage unit 12, and the element image generator 14, explained in the first embodiment, and a real-object additional-information storage unit 15 and an interaction calculator 16 provided based on the control performed by the processor 1 following the three-dimensional-image display program.

The real-object additional-information storage unit 15 stores information that can be added to Model_obj 131 expressing the real object 7, in the HDD 4, as real-object additional information.

The real-object additional information includes additional information concerning a virtual object that can be expressed in superposition with the real object 7 according to a result of interaction, and an attribute condition to be added at the time of generating Model_obj 131, for example. The additional information is content for a creative effect, such as a virtual object which expresses a crack in the real object 7, and a virtual object which expresses a hole in the real object 7, for example.

The attribute condition is a new attribute auxiliary added to the attribute of the real object 7, and it is, for example, a piece of information that can add an attribute as a mirror to Model_obj 131 representing the real object 7, or can add an attribute as a lens.

The interaction calculator 16 has a similar function as that of the interaction calculator 13 described above, and when Model_obj 131 representing the real object 7 is generated or according to a calculation result of the interaction between the Model_obj 131 and Model_other 132, the interaction calculator 16 reads out real-object additional information stored in the real-object additional-information storage unit 15 and performs a process of adding the real-object additional information.

A display mode of the three-dimensional-image display apparatus 100 according to the second embodiment is explained below with reference to FIGS. 15 to 18.

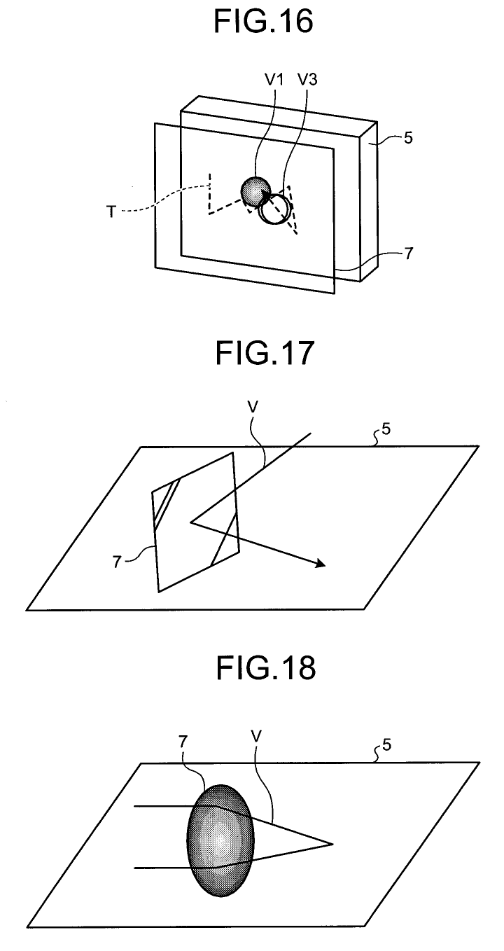

FIGS. 15 and 16 depict a state that the spherical virtual object V1 is displayed between the three-dimensional-image display unit 5 set vertically and the transparent flat-shaped real object 7 set vertically at a near position parallel with the display surface of the three-dimensional-image display unit 5. The real object 7 is an actual entity such as a transparent glass sheet and an acrylic sheet. The doted line T in the drawings expresses a motion track of the spherical virtual object V1.

In this configuration, the real-object position/posture-information storage unit 11 stores information for instructing that the real object 7 is set in parallel with the display surface at a position of a 10 centimeter distance from the display surface of the three-dimensional-image display unit 5, as real-object position/location information. The real-object attribute-information storage unit 12 stores attributes of the real object 7, such as a material, a shape, strength, thickness, and refractive index of an acrylic sheet and a glass sheet, as real-object attribute information.

The interaction calculator 16 generates Model_obj 131 expressing the real object 7, and generates Model_other 132 expressing the virtual objects V1, based on the real-object position/posture information and real-object attribute information, and calculates the interaction between both physical calculation models.

In the example shown in FIG. 15, a collision between the real object and the virtual object V1 can be taken as a determination standard at the interaction time. In this case, the interaction calculator 16 can obtain a calculation result that the spherical virtual object V1 bounces to the real object 7, as a result of the interaction between Model_obj 131 and Model_other 132. Further, the interaction calculator 16 displays the virtual object V3 to be displayed in superposition with the real object 7 based on the collision position, based on the calculation result for the interaction between both physical calculation models, and the real-object additional information stored in the real-object additional-information storage unit 15.

The element image generator 14 generates multi-viewpoint images by rendering, reflecting a calculation result of the interaction calculator 16 to at least one of Model_obj 131 and Model_other 132, and generates the element image array by rearranging the multi-viewpoint images. The element image generator 14 displays the generated element image array in the display space of the three-dimensional-image display unit 5, thereby displaying the virtual object V1 and displaying the virtual object V3 based on the collision position of the real object 7.

FIG. 15 is an example that displays the virtual object V3 which makes the real object appear that a crack is present in the real object 7. The virtual object V3 is three-dimensionally displayed on the real object 7 based on a collision position between the real object 7 and the virtual object V1, based on the generation and display in the above process.

FIG. 16 is an example that an additional image which appears to have a hole is superimposed, as the virtual object V3, with the real object 7, based on the collision position between the virtual object V1 and the real object 7, like that shown in FIG. 15. In the example shown in FIG. 16, it can be displayed such that the ball of the virtual object V1 dashes out from a hole displayed as the virtual object V3.

As explained above, natural amalgamation between the three-dimensional image and the real object can be achieved, by displaying the additional three-dimensional image (the virtual object) in superimposition with the real object 7, following the virtual interaction between the real object 7 and the virtual object V, thereby improving live feeling and presence feeling of the three-dimensional image.

FIG. 17 depicts another display mode of a three-dimensional image by the three-dimensional-image display apparatus 101. In this display mode, the transparent sheet-shaped real object 7 is vertically set on the three-dimensional-image display unit 5 set horizontally. The real object is a transparent glass sheet or acrylic sheet. The real-object position/posture-information storage unit 11 and the real-object attribute-information storage unit 12 store the real-object position/posture information and the real-object attribute information concerning the real object 7, respectively. The real-object additional-information storage unit 15 stores in advance an additional condition for instructing the attribute of a mirror (total reflection).

In the configuration shown in FIG. 17, the interaction calculator 16 reads the additional information for instructing the characteristics of the mirror (total reflection), and adds the additional information to Model_obj 131, at the time of generating Model_obj 131 expressing the real object 7. With this arrangement, the real object expressed by Model_obj 131 can be handled like a mirror. That is, at the time of calculating the interaction between Model_obj 131 and Model_other 132, the processing is performed based on Model_obj 131 which is added with the additional condition.

Therefore, as shown in FIG. 17, when Model_other 132 displays a ray by simulation as the virtual object V, the real object 7 is handled as a mirror, when the ray collides against the real object 7, based on the calculation result of the interaction by the interaction calculator 16. As a result, the virtual object V is displayed as being reflected by the real object 7, based on the position of collision between the real object 7 and the virtual object V.

FIG. 18 depicts a configuration that the real object 7 made of a transparent disk sheet such as a glass sheet and an acrylic sheet is vertically set on the three-dimensional-image display unit 5 set horizontally, like in the example shown in FIG. 17. The interaction calculator 16 adds an additional condition of adding the attribute of a lens (convex lens), to Model_obj 131 expressing the real object 7.

In this case, as shown in FIG. 18, when a ray displayed by simulation as the virtual object V expressed by Model_other 132 collides against the real object 7, the real object 7 is handled as a lens, based on the result of the interaction calculation performed by the interaction calculator 16. Therefore, the virtual object V is displayed as being refracted (concentrated) by the real object 7, based on the collision position between the real object 7 and the virtual object V.

As explained above, by simultaneously viewing the displayed three-dimensional image and the transparent real object 7, the observer can view the virtual expression that the ray is reflected by the mirror and is concentrated with the lens. To actually view the track of the ray, the ray needs to be scattered by spraying smoke in space. When children learn reflection and concentration of rays by lens, the facts that the optical element itself is expensive, is easily broken, and dislikes stain, need to be carefully taken into consideration. In the configuration of the second embodiment, the real object 7 such as the acrylic sheet virtually achieves the performance of the optical element. Therefore, the second embodiment is suitable for application to educational materials for children to learn the track of a ray.

As explained above, according to the second embodiment, the attribute of the real object 7 can be virtually expanded, by adding new attribute at the time of generating Model_obj 131 expressing the real object 7. This can achieve natural amalgamation between the three-dimensional image and the real object, and improve interactiveness.

A three-dimensional-image display apparatus according to a third embodiment of the present invention is explained next. Constituent elements similar to those in the first embodiment are denoted by like reference numerals, and explanations thereof will be omitted.

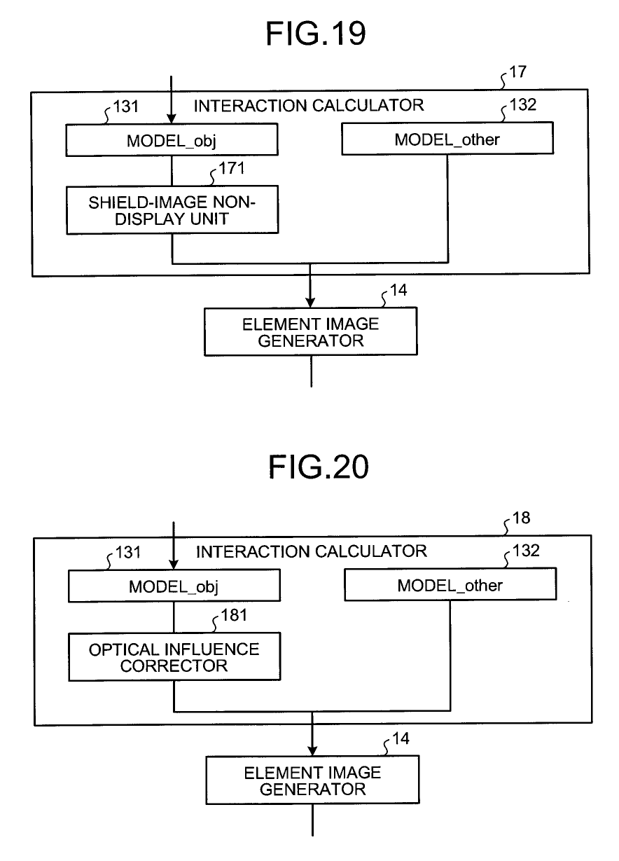

FIG. 19 is a block diagram of a configuration of an interaction calculator 17 according to the third embodiment. As shown in FIG. 19, the interaction calculator 17 includes a shield-image non-display unit 171 provided based on the control performed by the processor 1 following the three-dimensional-image display program. Other functional units have configurations similar to those explained in the first embodiment or the second embodiment.

The shield-image non-display unit 171 calculates a light shielding region in which rays that the three-dimensional-image display unit 5 irradiates to the real object 7 are shielded, based on the position and posture of the real object 7 that the real-object position/posture-information storage unit 11 stores as the real-object position/posture information, and the shape of the real object 7 that the real-object attribute-information storage unit 12 stores as the real-object attribute information.

Specifically, the shield-image non-display unit 171 generates a CG model from Model_obj 131 expressing the real object 7, and regenerates by calculation a state that the ray emitted from the three-dimensional-image display unit 5 is irradiated to the CG model, thereby calculating the region of the CG model in which the ray emitted by the three-dimensional-image display unit 5 is shielded.

The shield-image non-display unit 171 also generates Model_obj 131 from which the CG model part corresponding to the calculated light shielding region is removed immediately before the generation of each viewpoint image by the element image generator 14, calculates the interaction between this Model_obj 131 and Model_other 132.

As explained above, according to the third embodiment, it is possible to prevent the display of the three-dimensional image at the shielded part of the real object 7. Therefore, a display with little sense of discomfort from the viewpoint of the observer can be achieved, by suppressing the sense of discomfort such as a double image when the position of the shielded part is deviated from the position of the three-dimensional image.

In the third embodiment, the shielded region is calculated by regenerating by calculation the state that a ray emitted from the three-dimensional-image display unit 5 is irradiated to the CG model. When information corresponding to the shielded region is stored in advance as the real-object position/posture information or the real-object attribute information, the display of the three-dimensional image can be controlled using this information. When a functional unit (a real-object position/posture detector 19) described later that can detect the position and posture of the real object 7 is provided, this functional unit can calculate the light shielding region, based on the position and posture of the real object 7 obtained in real time.

A three-dimensional-image display apparatus according to a fourth embodiment of the present invention is explained next. Constituent elements similar to those in the first embodiment are denoted by like reference numerals, and explanations thereof will be omitted.

FIG. 20 is a block diagram of a configuration of an interaction calculator 18 according to the fourth embodiment. As shown in FIG. 20, the interaction calculator 18 includes an optical influence corrector 181 provided based on the control performed by the processor 1 following the three-dimensional-image display program. Other functional units have configurations similar to those explained in the first embodiment or the second embodiment.

The optical influence corrector 181 corrects Model_obj 131 so that a virtual object appears in a predetermined state when the virtual object is displayed in superposition with the real object 7.

For example, when the refractive index of the transparent portion of the real object 7 is higher than that of air and also when the real object 7 has a curved shape, this transparent portion exhibits the effect of a lens. In this case, the optical influence corrector 181 generates Model_obj 131 that offsets the lens effect, by correcting the item contributing to the refractive index of the real object 7 contained in Model_obj 131, to control such that the lens effect does not occur in appearance.

When the real object 7 has an optical characteristic (absorbing the wavelength of yellow color) that the real object 7 appears bluish under the incandescent light, for example, the incandescent light emitted from the three-dimensional-image display unit 5 is observed as bluish based on the light absorption effect. In this case, the optical influence corrector 181 corrects the color observed when the virtual object is displayed in superposition, by correcting the item contributing to the display color contained in Model_obj 131. For example, to make the light emitted from the injection pupil of the three-dimensional-image display unit 5 finally look red via the transparent portion of the real object 7, the color of the virtual object corresponding to the transparent portion is generated in orange color.

The element image generator 14 generates the multi-viewpoint images by rendering, by reflecting the result of calculation by Model_obj 131 corrected by the optical influence corrector 181, and generates the element image array by rearranging the multi-viewpoint images. The generated element image array is displayed in the display space of the three-dimensional-image display unit 5, thereby performing the three-dimensional display of the virtual object.

In expressing color in the transparent portion of the real object 7 using the light of the three-dimensional-image display unit 5, this can be achieve by displaying the colored virtual object in superimposition to cover the transparent portion of the real object 7. When the real object 7 has a predetermined scattering characteristic, color can be more efficiently provided by emitting light based on this characteristic.

The scattering characteristic of the real object 7 means a scattering level of light incident to the real object 7. For example, when the real object 7 includes an element containing fine air bubbles and also when the refractive index of the real object 7 is higher than one, light is scattered by the fine air bubbles. Therefore, the scattering rate becomes higher than that of a homogeneous transparent material.

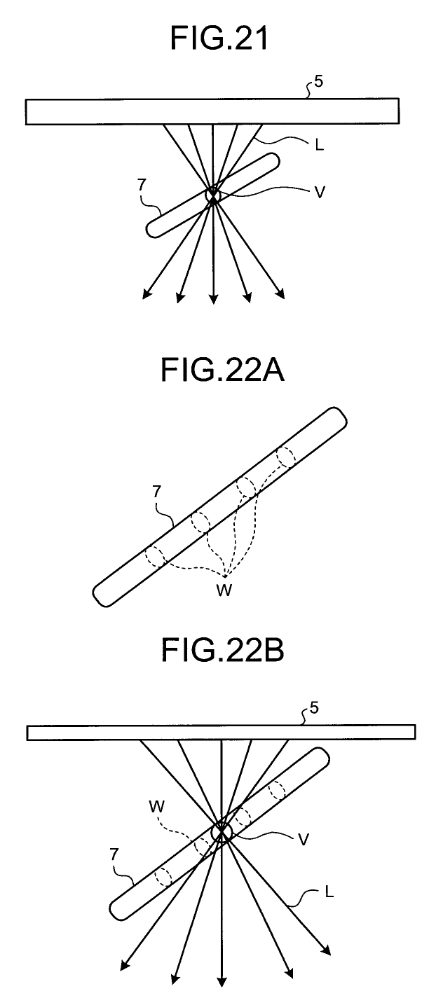

When the refractive index of the real object 7 is higher than one and also when the light scattering level is equal to or higher than a predetermined value, the optical influence corrector 181 controls the virtual object V to be displayed as a luminescent spot at an optional position within the real object 7, thereby presenting the whole real object 7 with a predetermined color and brightness, as shown in FIG. 21. In FIG. 21, L represents light emitted from the injection pupil of the three-dimensional-image display unit 5. Accordingly, the whole real object 7 can be presented with a predetermined color and brightness, under more robust control than that of displaying the virtual object in superposition with the transparent portion of the real object 7.

As shown in FIG. 22A, plural light shielding walls W can be provided within the real object 7 having the refractive index higher than one and having the light scattering level equal to or higher than a predetermined value, thereby separating the real object 7 into plural regions. In this case, the optical influence corrector 181 controls the virtual object V to be displayed as a luminescent spot within any one region, thereby presenting color in the region unit, as shown in FIG. 22B.

When the real object 7 shown in FIG. 22A is used, the real-object attribute-information storage unit 12 stores information for specifying each region, including a position of the wall incorporated in the real object 7, as the real-object attribute information. While FIG. 22B depicts a state of displaying the luminescent spot in one region, the luminescent spots can be also displayed in plural regions, and luminescent spots of different colors can be displayed in the respective regions.

As explained above, according to the fourth embodiment, Model_obj 131 is corrected so that the three-dimensional image displayed in the transparent portion of the real object 7 becomes in a predetermined display state. Therefore, the three-dimensional image can be presented to the observer in a desired way of appearance, without depending on the attribute of the real object 7.

A three-dimensional-image display apparatus according to a fifth embodiment of the present invention is explained next. Constituent elements similar to those in the first embodiment are denoted by like reference numerals, and explanations thereof will be omitted.

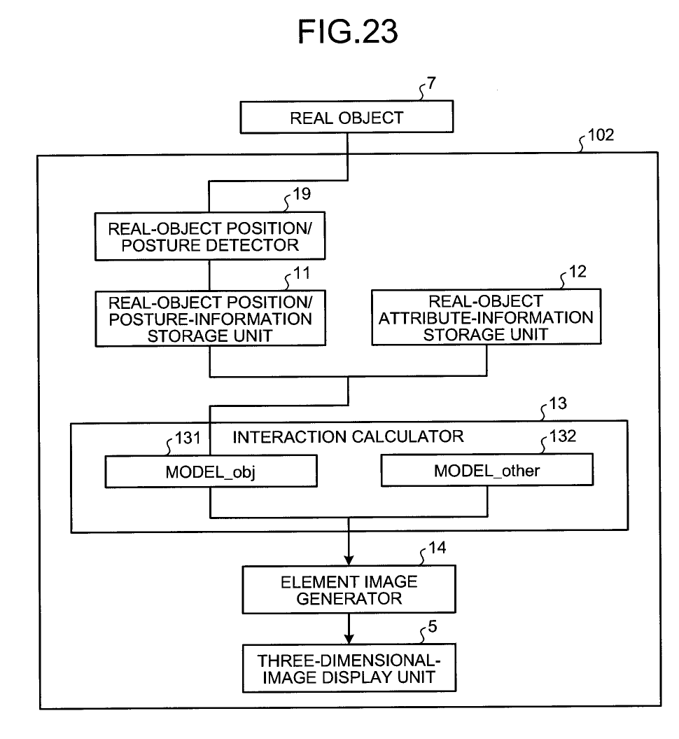

FIG. 23 is a block diagram of a configuration of a three-dimensional-image display apparatus 102 according to the fifth embodiment. As shown in FIG. 23, the three-dimensional-image display apparatus 102 includes the real-object position/posture detector 19, in addition to the functional units explained in the first embodiment, based on the control performed by the processor 1 following the three-dimensional-image display program.

The real-object position/posture detector 19 detects the position and posture of the real object 7 laid out on the display surface of the three-dimensional-image display unit 5 or near the display surface, and stores the position and posture, as the real-object position/posture information, into the real-object position/posture-information storage unit 11. The position of the real object 7 means a position relative to the position of the three-dimensional-image display unit 5. The posture of the real object 7 means a direction and angle of the real object 7 relative to the display surface of the three-dimensional-image display unit 5.

Specifically, the real-object position/posture detector 19 detects the current position and posture of the real object 7, based on a signal transmitted by wire or wireless communication from a position/posture-detecting gyro-sensor mounted on the real object 7, and stores the position and posture, as the real-object position/posture information, into the real-object position/posture-information storage unit 11. With this arrangement, the real-object position/posture detector 19 acquires the position and posture of the real object 7 in real time. The real-object attribute-information storage unit 12 stores in advance the real-object attribute information concerning the real object 7 of which position and posture is detected by the real-object position/posture detector 19.

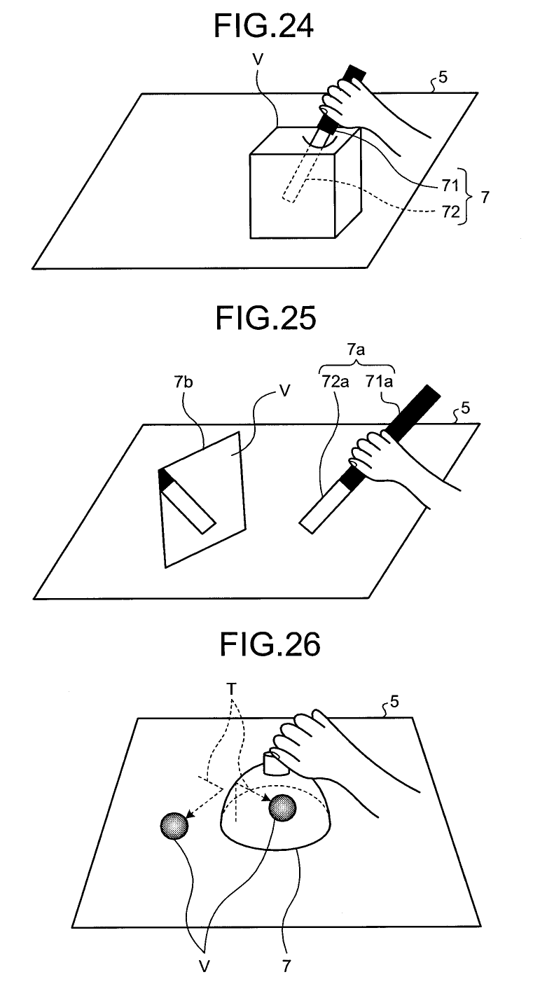

FIG. 24 is a schematic diagram for explaining the operation of the three-dimensional-image display apparatus 102 according to the fifth embodiment. In FIG. 24, the rectangular solid virtual object V is a three-dimensional image displayed in the display space of the three-dimensional-image display unit 5 set horizontally under the control of the interaction calculator 13.

The real object 7 includes a light shielding portion 71, and a transparent portion 72. The observer of the present device can freely move the light shielding portion 71 of the real object 7 by holding the light shielding portion 71 within the display space of the three-dimensional-image display unit 5.

In the configuration of FIG. 24, the real-object position/posture detector 19 acquires in real time the position and posture of the real object 7, and sequentially stores the position and posture into the real-object position/posture-information storage unit 11, as one element of the real-object position/posture information. The interaction calculator 13 generates Model_obj 131 expressing the present real object 7, based on the real-object position/posture information and the real-object attribute information, matching the updating of the real-object position/posture information, and calculates the interaction between Model_obj 131 and Model_other 132 expressing the virtual object V generated separately.

When the real object 7 is moved to a position superimposed with the virtual object V based on the operation of the observer, the interaction calculator 13 calculates the interaction between Model_obj 131 and Model_other 132, and displays the virtual object V based on the calculation result, via the element image generator 14. FIG. 24 is an example that the virtual object V expresses a recessed state, based on a position of contact between the real object 7 and the virtual object V. Based on this display control, the observer can view a state that the real object 7 enters the virtual object V via the transparent portion 72 of the real object 7.

FIG. 25 depicts another display mode, and depicts a configuration that the three-dimensional-image display unit 5 is set horizontally. A real object 7a includes a light shielding portion 71a, and a transparent portion 72a. A position/posture detecting gyro-sensor is provided in the light shielding portion 71a. The observer (the operator) can freely move the real object 7a on the three-dimensional-image display unit 5, by grasping the real object 7a.

A real object 7b is a transparent flat object, and is vertically set on the display surface of the three-dimensional-image display unit 5. The virtual object V having the same shape as that of the real object 7b having the attribute of a mirror is displayed in superposition with the real object 7b, via the element image generator 14, based on the display control of the interaction calculator 13.

In the configuration of FIG. 25, when the real-object position/posture detector 19 detects the position and posture of the real object 7a, and also when the detected position and posture is stored as one element of the real-object position/posture information, into the real-object position/posture-information storage unit 11, the interaction calculator 13 generates Model_obj 131 corresponding to the real object 7a, and calculates the interaction between Model_obj 131 and Model_other 132 expressing the virtual object V displayed in superposition with the real object 7b. That is, the interaction calculator 13 generates a CG model having the same shape (the same attribute) as that of the real object 7a, as Model_obj 131 expressing the real object 7a, and calculates the interaction between this CG model and the CG model of the real object 7b added with the attribute of the mirror.

For example, as shown in FIG. 25, when the real object 7a moves to a position at which a part or the whole of the real object 7a is reflected in the surface (the mirror surface) of the real object 7b, based on the operation of the operator, the interaction calculator 13 calculates the reflected part of the real object 7a in the interaction calculation, and controls such that a two-dimensional image of the CG model corresponding to the reflected part of the real object 7a is displayed in superposition with the real object 7b, as the virtual object V.

As explained above, according to the fifth embodiment, the position and posture of the real object 7 can be acquired in real time. Therefore, natural amalgamation between the three-dimensional image and the real object can be achieved in real time, thereby improving the live feeling and the sense of presence of the three-dimensional image, and more improving the interactiveness.

In the fifth embodiment, while the gyro-sensor incorporated in the real object 7 detects the position of the real object 7, the detection mode is not limited to this, and another detecting mechanism can be used.

For example, an infrared-ray-image sensor system can be used that irradiates infrared rays to the real object 7 from around the three-dimensional-image display unit 5, and detects the position of the real object 7 based on the reflection level. In this case, a mechanism of detecting the position of the real object 7 can include an infrared emitter that emits infrared rays, an infrared detector that detects the infrared rays, and a retroreflective sheet that reflects the infrared rays (not shown). The infrared emitter and the infrared detector are provided at both ends respectively of any one of the four sides configuring the display surface of the three-dimensional-image display unit 5. The retroreflective sheet that reflects the infrared rays is provided on the remaining three sides, thereby detecting the position of the real object 7 on the display surface.

FIG. 26 is a pattern diagram of a state that a transparent hemispherical real object 7 is mounted on the display surface of the three-dimensional-image display unit 5. When the real object 7 on the display surface is present, infrared rays emitted from the infrared emitters (not shown) provided at both ends of the one side (for example, the left side in FIG. 26) of the display surface are shielded by the real object 7. The real-object position/posture detector 19 specifies, based on the trigonometric system, a position at which infrared rays are not detected, that is, the presence position of the real object 7, based on the reflected light (the infrared rays) reflected by the retroreflective sheet detected by the infrared detector.

The real-object position/posture-information storage unit 11 stores the position of the real object 7 specified by the real-object position/posture detector 19, as one element of the real-object position/posture information, and the interaction calculator 13 calculates the interaction between the real object 7 and the virtual object V. The virtual object V on which the calculation result is reflected is displayed in the display space of the three-dimensional-image display unit 5 via the element image generator 14. The dotted line T expresses the motion track of the spherical virtual object V.

When the infrared image sensor system is used, the real object 7 has a hemispherical shape having no anisotropy, as shown in FIG. 26. With this arrangement, the real object 7 can be handled as a point. A region of the real object 7 occupying the display space of the three-dimensional-image display unit 5 can be determined from one-point detection position. When frosted-glass opaque processing is preformed or a translucent seal is adhered to the region in which the infrared rays of the real object 7 are irradiated, this can improve detection precision of the infrared detector using the effect of translucency of the real object 7 itself.

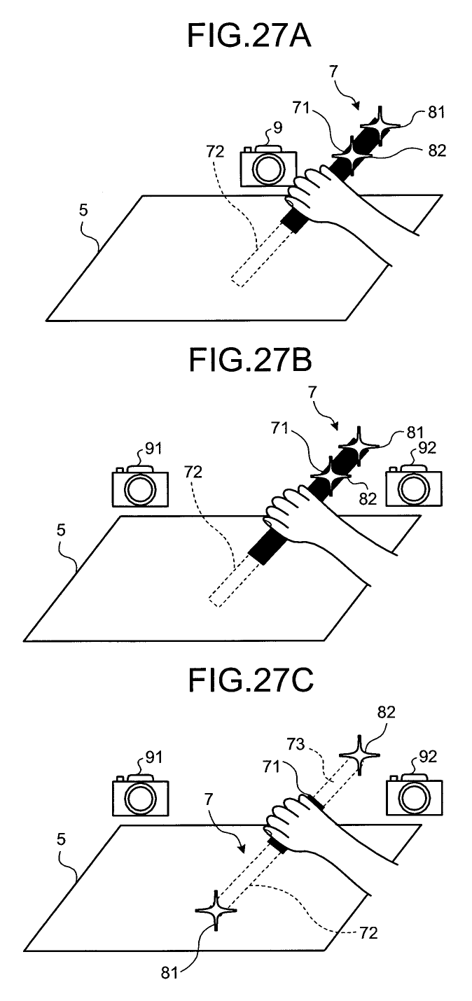

FIG. 27A to FIG. 27C are schematic diagrams for explaining a method of detecting the position and posture of the real object 7 according to another method. The method of detecting the position and posture of the real object 7 using an imaging device such as a digital camera is explained with reference to FIG. 27A to FIG. 27C.

In FIG. 27A, the real object 7 includes the light shielding portion 71, and the transparent portion 72. Two light emitters 81 and 82 that emit infrared rays or the like are provided in the light shielding portion 71. The real-object position/posture detector 19 analyzes an image of two light spots picked up with an imaging device 9, thereby specifying the position and posture of the real object 7 on the display surface of the three-dimensional-image display unit 5.

Specifically, the real-object position/posture detector 19 specifies the position of the real object 7 using the trigonometric system, based on the distance between the two light spots contained in the picked-up image, and the position of the imaging device 9. The real-object position/posture detector 19 is assumed to understand beforehand the distance between the light emitters 81 and 82. The real-object position/posture detector 19 can specify the sizes of the two light spots contained in the picked-up image, and the posture of the real object 7 from the vector connecting between the two light spots.

FIG. 27B is a pattern diagram when two imaging devices 91 and 92 are used. The real-object position/posture detector 19 specifies the position and posture, using the trigonometric system, based on the two light spots contained in the picked-up image, like the configuration shown in FIG. 27A. The real-object position/posture detector 19 can specify the position of the real object 7 in higher precision than that of the configuration shown in FIG. 27A, by specifying the position of each light spot, based on the distance between the imaging devices 91 and 92. The real-object position/posture detector 19 is assumed to understand beforehand the distance between the imaging devices 91 and 92.

There is a fact that the precision of triangulation improves when the distance between the light emitters 81 and 82 explained with reference to FIGS. 27A and 27B increases. FIG. 27C depicts a configuration that both ends of the real object 7 are the light emitters 81 and 82.

In FIG. 27C, the real object 7 includes the light shielding portion 71, and the transparent portion 72 and 73 provided at both ends of the light shielding portion 71. The light shielding portion 71 incorporates a light source (not shown) that emits light to the directions of the transparent portions 72 and 73. A scattering portion that scatters light is formed at the front part of the transparent portions 72 and 73, respectively. That is, the transparent portion 72 and 73 are used as light guide paths, and the scattering portions of the transparent portions 72 and 73 emit light via the light guide paths. With this arrangement, the front ends of the transparent portions 72 and 73 function as the light emitters 81 and 82. The imaging devices 91 and 92 image the lights of the light emitters 81 and 82, and output the images as picked-up images, to the real-object position/posture detector 19, thereby specifying the position of the real object 7 in higher precision. The scattering positions at the front end of the transparent portions 72 and 73 can be provided using the cross section of acrylic resin, for example.

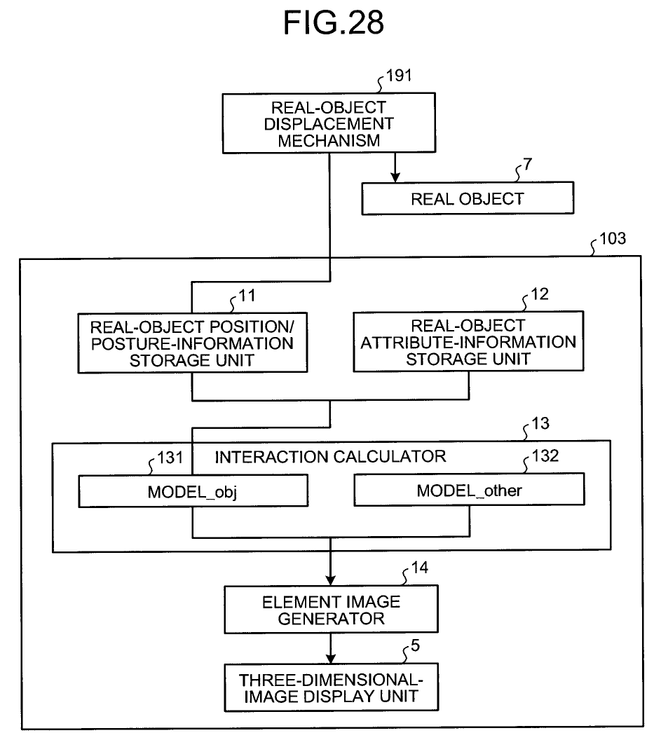

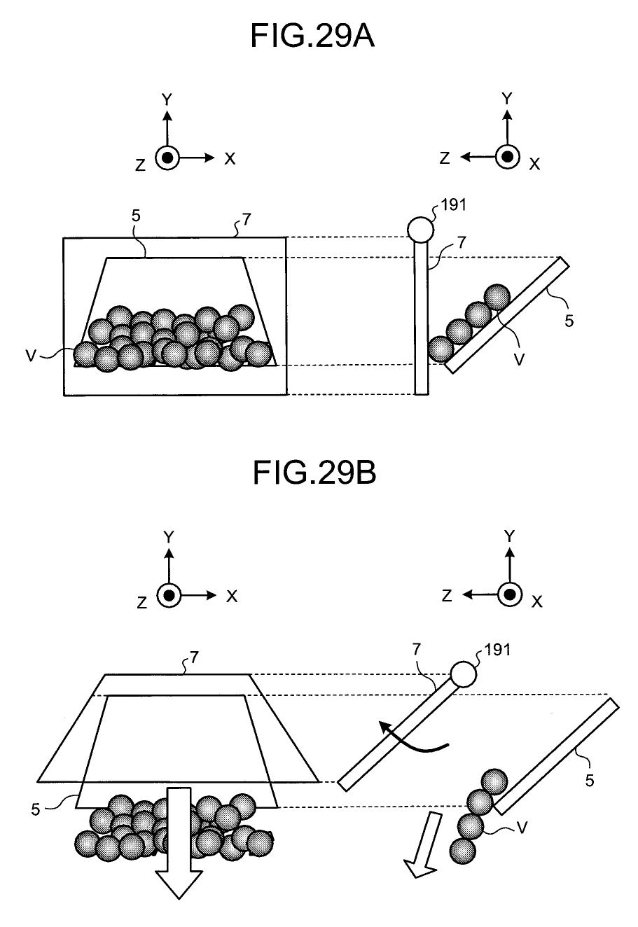

A modification of the three-dimensional-image display apparatus 102 according to the fifth embodiment is explained with reference to FIG. 28, FIG. 29A, and FIG. 29B.

FIG. 28 is a block diagram of a configuration of a three-dimensional-image display apparatus 103 according to the modification of the fifth embodiment. As shown in FIG. 28, the three-dimensional-image display apparatus 103 includes a real-object displacement mechanism 191, in addition to the functional units explained in the first embodiment.

The real-object displacement mechanism 191 includes a driving mechanism such as a motor that displaces the real object 7 to a predetermined position and posture, and displaces the real object 7 to a predetermined position and posture according to an instruction signal input from an external device (not shown). The real-object displacement mechanism 191 detects the position and posture of the real object 7 relative to the display surface of the three-dimensional-image display unit 5, based on the driving amount of the driving mechanism, and stores the detected position and posture as the real-object position/posture information, into the real-object position/posture-information storage unit 11.

The operations after the real-object position/posture-information storage unit 11 stores the real-object position/posture information are similar to those performed by the interaction calculator 13 and the element image generator 14, and therefore explanations thereof will be omitted.

FIG. 29A and FIG. 29B depict detailed configuration examples of the three-dimensional-image display apparatus 103 according to the present modification. The transparent sheet-shaped real object 7 is vertically laid out near the lower end of the three-dimensional-image display unit 5 installed with an inclination of 45 degrees relative to the horizontal surface.

The left parts in FIGS. 29A and 29B are front views of the real object 7 when the real object 7 is looked at from the front direction (the Z axis direction), and the right parts in FIGS. 29A and 29B are right-side views of the real object 7 in the respective drawings. The real-object displacement mechanism 191 that rotates the real object 7 to the front direction of the real object 7 is provided at the upper front end of the real object 7, with the upper front end as a supporting point, thereby displacing the position and posture of the real object 7 according to an instruction signal input from the external device.

As shown in FIG. 29A, as a result of the calculation of the interaction between Model_obj 131 expressing the real object 7 and Model_other 132 expressing the virtual objects V corresponding to plural balls, a state that plural spherical virtual objects V1 are accumulated in the valley between the real object 7 and the three-dimensional-image display unit 5 is displayed.

In this state, when the real-object displacement mechanism 191 is driven based on the instruction signal input from the external device, the real-object displacement mechanism 191 detects the position and posture of the real object 7 on the display surface of the three-dimensional-image display unit 5, based on the driving amount of the driving mechanism. In the present configuration, the driving amount (displacement amount) of the real object 7 depends on the rotation angle. Therefore, the real-object displacement mechanism 191 calculates a value corresponding to the rotation angle from the position and posture of the real object 7 in the stationary state, and stores the value as the real-object position/posture information, into the real-object position/posture-information storage unit 11.

The interaction calculator 13 generates Model_obj 131 expressing the real object 7, using the real-object position/posture information and the real-object attribute information updated by the real-object displacement mechanism 191, and calculates the interaction between Model_obj 131 and Model_other 132 expressing the virtual objects V including plural balls. In this case, as shown in FIG. 29B, the interaction calculator 13 can obtain a calculation result that the virtual objects V accumulated in the valley between the real object 7 and the three-dimensional-image display unit 5 fall down in rotation through a gap generated between the real object 7 and the three-dimensional-image display unit 5.

The element image generator 14 generates by rendering multi-viewpoint images by reflecting the calculation result of the interaction calculator 13 to at least one of Model_obj 131 and Model_other 132, and generates the element image array by rearranging the multi-viewpoint images. The element image generator 14 displays the generated element image array, in the display space of the three-dimensional-image display unit 5, thereby performing the three-dimensional display of the virtual object V1.

The observer simultaneously views the three-dimensional image generated and displayed in the above process and the transparent real object 7, and can view the state that the balls as the virtual objects V fall from the gap generated by the move of the real object 7, from the accumulated state of the balls, by using the transparent real object 7.

As explained above, according to the present modification, the position and posture of the real object 7 can be acquired in real time, like that performed by the three-dimensional-image display apparatus according to the fifth embodiment. Therefore, this can achieve natural amalgamation between the three-dimensional image and the real object in real time, and can improve live feeling and sense of presence of the three-dimensional image, with improved interactiveness.

A three-dimensional-image display apparatus according to a sixth embodiment of the present invention is explained next. Constituent elements similar to those in the first and fifth embodiments are denoted by like reference numerals, and explanations thereof will be omitted.

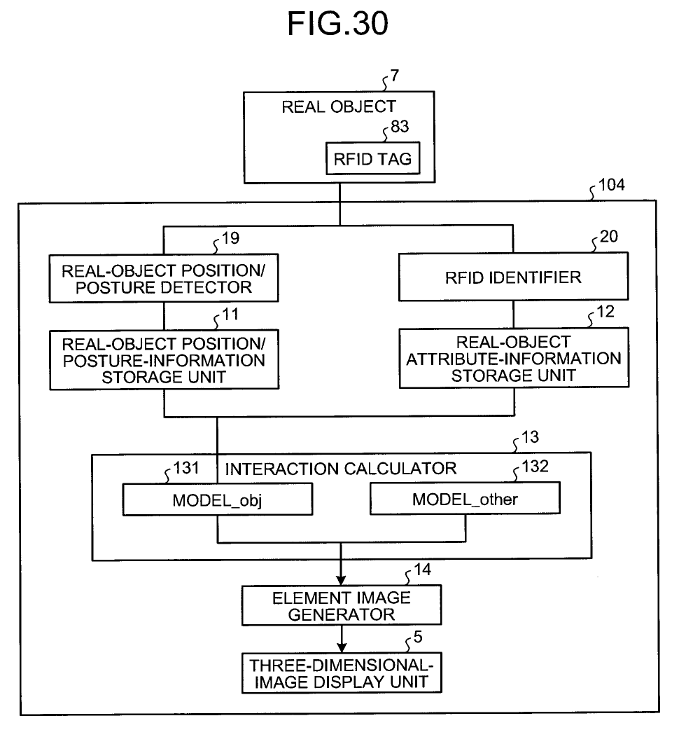

FIG. 30 is a block diagram of a configuration of a three-dimensional-image display apparatus 104 according to the sixth embodiment. As shown in FIG. 30, the three-dimensional-image display apparatus 104 includes a radio frequency identification (RFID) identifier 20, in addition to the functional units explained in the fifth embodiment, based on the control performed by the processor 1 following the three-dimensional-image display program.

The real object 7 used in the sixth embodiment includes RFID tags 83, and specific real-object attribute information is stored in each RFID tag 83.

The RFID identifier 20 has an antenna that controls the emission direction of waves to contain the display space of the three-dimensional-image display unit 5, reads the real-object attribute information stored in the RFID tag 83 of the real object 7, and stores the read information into the real-object attribute-information storage unit 12. The real-object attribute information stored in the RFID tag 83 contains shape information for instructing a spoon shape, a knife shape, or a fork shape, and physical characteristic information such as optical characteristics.

The interaction calculator 13 reads the real-object position/posture information stored by the real-object position/posture detector 19, from the real-object position/posture-information storage unit 11, reads the real-object attribute information stored by the RFID identifier 20, from the real-object attribute-information storage unit 12, and generates Model_obj 131 expressing the real object 7, based on the real-object position/posture information and the real-object attribute information. Model_obj 131 generated in this way is displayed in superimposition with the real object 7, as a virtual object RV, via the element image generator 14.

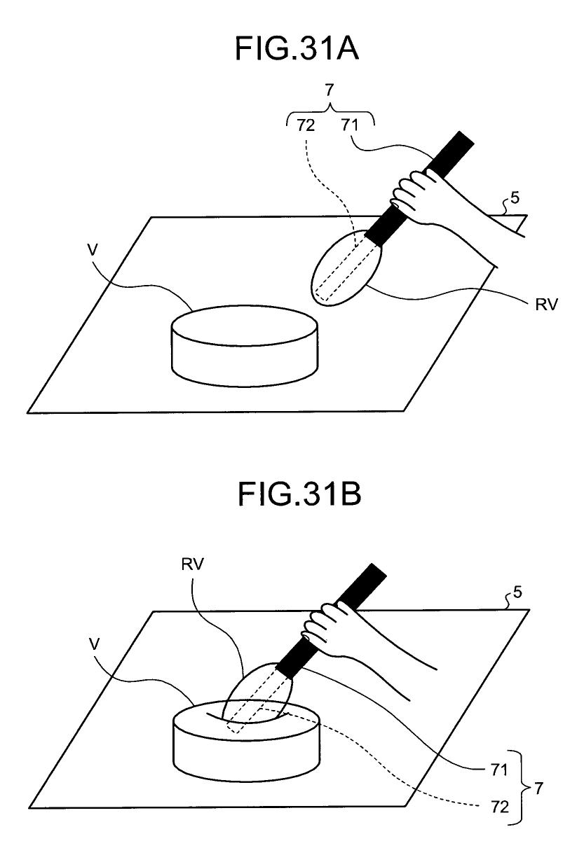

FIG. 31A is a display example of the virtual object RV that the RFID tag 83 contains the shape information for instructing a spoon shape. The real object 7 includes the light shielding portion 71, and the transparent portion 72. The RFID tag 83 is provided in the light shielding portion 71 and the like. In this case, when the RFID identifier 20 reads the RFID tag 83 of the real object 7, the spoon-shaped virtual object RV is displayed to contain the transparent portion 72 of the real object 7, in the display space of the three-dimensional-image display unit 5, as shown in FIG. 31A.

In the sixth embodiment, the interaction calculator 13 calculates the interaction between the virtual object RV and other virtual object V so that the virtual object RV (a spoon) in FIG. 31A can be expressed to enter the column-shaped virtual object V (for example, a cake), as shown in FIG. 31B.

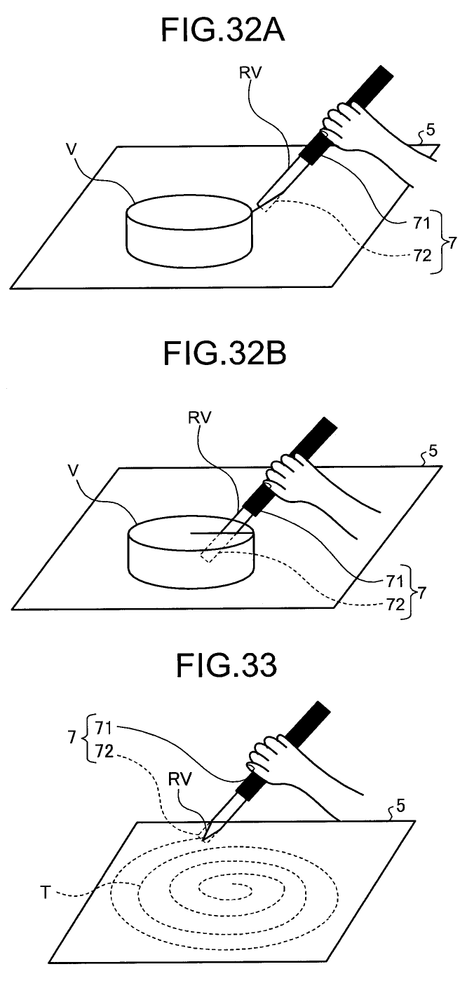

FIG. 32A is a display example of the virtual object RV that the RFID tag 83 contains the shape information for instructing a knife shape. Like in FIG. 31A, the real object 7 includes the light shielding portion 71, and the transparent portion 72, and the RFID tag 83 is provided in the light shielding portion 71 and the like. In this case, when the RFID identifier 20 reads the RFID tag 83 of the real object 7, the knife-shaped virtual object RV is displayed to contain the transparent portion 72 of the real object 7, in the display space of the three-dimensional-image display unit 5, as shown in FIG. 32A.

In FIG. 32A, the interaction calculator 13 calculates the interaction between the virtual object RV and another virtual object V so that the virtual object RV (the knife) in FIG. 32A can be expressed to cut the column-shaped virtual object V (for example, a cake), as shown in FIG. 32B. When the knife shape is displayed as the virtual object RV as explained above, preferably the cutting edge of the knife shape is displayed to correspond to the transparent portion 72 of the real object 7. Accordingly, the observer can operate to cut the cake while acquiring the feeling that the transparent portion 72 is in contact with the display surface of the three-dimensional-image display unit 5. As a result, live feeling and sense of presence of the virtual object RV can be improved while improving the operability.

FIG. 33 depicts another mode of the sixth embodiment, expressing a display example of the virtual object RV that the RFID tag 83 contains the shape information for instructing a pen shape. Like in FIG. 31A, the real object 7 includes the light shielding portion 71, and the transparent portion 72, and the RFID tag 83 is provided in the light shielding portion 71 and the like. In this case, when the RFID identifier 20 reads the RFID tag 83 of the real object 7, the pen-shaped virtual object RV is displayed to contain the transparent portion 72 of the real object 7, in the display space of the three-dimensional-image display unit 5, as shown in FIG. 33.

In the mode shown in FIG. 33, the pen-point-shaped virtual object RV is interlocked with the move of the real object 7 by the operation of the observer, thereby displaying the virtual object RV in superposition with the transparent portion 72. At the same time, the move track T is displayed on the display screen of the three-dimensional-image display unit 5. With this arrangement, a state that the pent point expressed by the virtual object RV draws a line can be displayed. When the pen-point shape is displayed as the virtual object RV in this way, preferably the front end of the pen-point shape is displayed to correspond to the transparent portion 72 of the real object 7. Accordingly, the observer can operate to draw a line while obtaining a feeling that the transparent portion 72 is in contact with the display surface of the three-dimensional-image display unit 5. As a result, this can improve live feeling and sense of presence of the virtual object RV while improving the operability.

As explained above, according to the sixth embodiment, the attribute that the real object 7 originally owns can be virtually expanded, by adding a new attribute, at the time of generating Model_obj 131 expressing the real object 7, thereby improving the interactiveness.

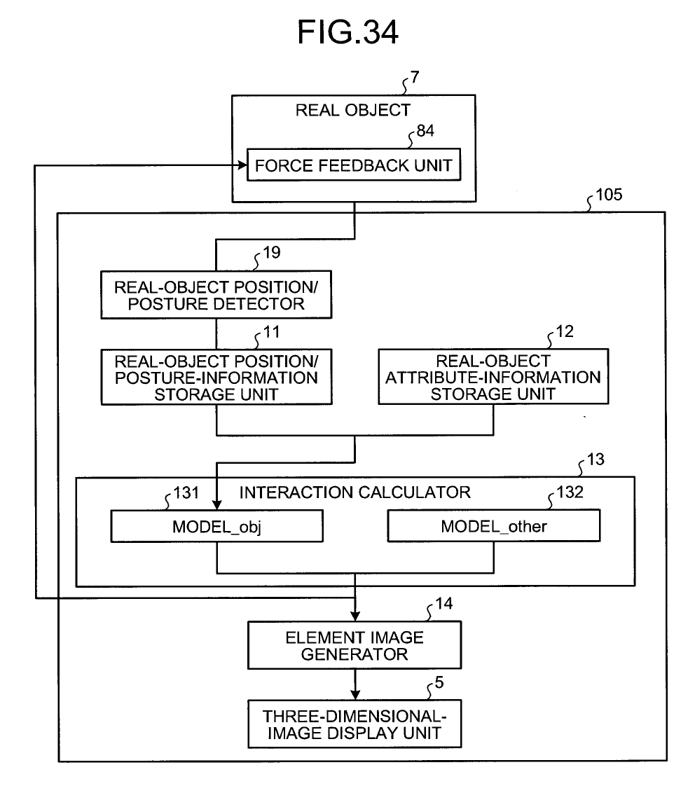

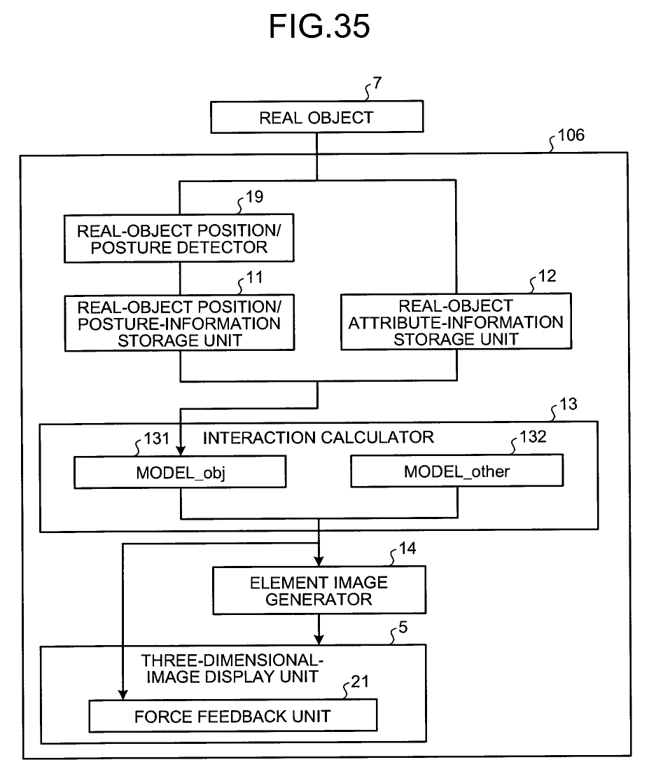

A force feedback unit described later (see FIGS. 34 and 35) can be added to the configuration of the sixth embodiment. In this configuration, when a force feedback unit 84 provided in the three-dimensional-image display unit 5 is used, the observer can feel the contact (such as rough surface paper) when the pen point displayed by the virtual object RV touches the display surface of the three-dimensional-image display unit 5, thereby improving live feeling and sense of presence of the virtual object RV.

A three-dimensional-image display apparatus according to a seventh embodiment of the present invention is explained next. Constituent elements similar to those in the first and fifth embodiments are denoted by like reference numerals, and explanations thereof will be omitted.

FIG. 34 is a block diagram of a configuration of a three-dimensional-image display apparatus 105 according to the seventh embodiment. As shown in FIG. 34, the three-dimensional-image display apparatus 105 includes the force feedback unit 84, in addition to the functional units explained in the fifth embodiment.

The force feedback unit 84 generates shock or vibration according to an instruction signal from the interaction calculator 13, and adds vibration or force to the operator's hand grasping the real object 7. Specifically, when the calculation result of the interaction between Model_obj 131 expressing the real object 7 (the transparent portion 72) and Model_other 132 expressing the virtual object V shown in FIG. 24 is displayed, the interaction calculator 13 transmits the instruction signal to the force feedback unit 84, thereby driving the force feedback unit 84 and making the operator of the real object 7 feel the shock of the collision. Communications between the reaction calculator 13 and the force feedback unit 84 can be performed by wire or wireless.

While the configuration having the force feedback unit 84 provided in the real object 7 is explained in the example shown in FIG. 34, the configuration is not limited to this. The installation position of the force feedback unit 84 is not limited when the observer can feel the vibration. FIG. 35 depicts another configuration example of the seventh embodiment. A three-dimensional-image display apparatus 106 includes a force feedback unit 21 within the three-dimensional-image display unit 5, in addition to the functional units explained in the fifth embodiment.

The force feedback unit 21 generates shock or vibration according to the instruction signal from the interaction calculator 13, and adds vibration and force to the three-dimensional-image display unit 5, like the force feedback unit 84. Specifically, when the calculation result of the interaction between Model_obj 131 expressing the real object 7 and Model_other 132 expressing the spherical virtual object V1 shown in FIG. 8 expresses a collision, the interaction calculator 13 transmits the instruction signal to the force feedback unit 21, thereby driving the force feedback unit 21 and making the observer feel the shock of the collision. In this case, although the observer does not grasp the real object 7, the observer can further improve live feeling of the virtual object or sense of presence, based on shock given to the observer when the spherical virtual object V1 collides against the real object 7.

Although not shown, an acoustic generator such as a speaker is provided in at least one of the real object 7 and the three-dimensional-image display unit 5, and the acoustic generator outputs effect sound of collision or effect sound such as cracking of glass according to an instruction signal from the interaction calculator 13, thereby further improving live feeling.

As explained above, according to the seventh embodiment, the force feedback device or the acoustic generator is driven according to the calculation result of the virtual interaction between the real object 7 and the virtual object, thereby improving live feeling and sense of presence of the three-dimensional image.

While embodiments of the present invention have been explained above, the invention is not limited thereto, and various changes, substitutions, and additions can be made within the scope of the appended claims.

The program executed by the three-dimensional-image display apparatus according to the first to seventh embodiments is incorporated in the ROM 2 or the HDD 4 in advance and provided. However, the method is not limited thereto, and the program can provided by being stored in a computer-readable recording medium, such as a compact-disk read only memory (CD-ROM), a flexible disk (FD), a digital versatile disk (DVD), as a file of an installable format or an executable format. Besides, the program can be stored in a computer connected to a network such as the Internet, and then downloaded via the network to be provided, or the program can be provided or distributed via a network such as the Internet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A three-dimensional-image display system comprising:
a display that displays a three-dimensional image within a display space according to a space image mode; and
a real object having at least a part of which laid out in the display space is a transparent portion, wherein
the display includes:
a position/posture-information storage unit that stores position posture information expressing a position and posture of the real object;
an attribute-information storage unit that stores attribute information expressing attribute of the real object;
a first physical-calculation model generator that generates a first physical-calculation model expressing the real object, based on the position/posture information and the attribute information;
a second physical-calculation model generator that generates a second physical-calculation model expressing a virtual external environment of the real object within the display space;
a calculator that calculates interaction between the first physical-calculation model and the second physical-calculation model; and
a display controller that controls the display for displaying a three-dimensional image within the display space, based on the interaction.

2. The system according to claim 1, wherein the display controller controls based on the interaction to at least one of a three-dimensional image expressed by the first physical-calculation model generator and a three-dimensional image expressed by the second physical-calculation model generator.

3. The system according to claim 1, wherein the display further includes:
an additional-information storage unit that stores another attribute different from the attribute of the real object, as additional information, wherein
the first physical-calculation model generator generates the first physical-calculation model, based on the additional information as well as the position/posture information and the attribute information.

4. The system according to claim 2, wherein the display controller further includes an image non-display unit that makes a region corresponding to at least a part of the real object non-displayed, out of three-dimensional images displayed by the first physical-calculation model.

5. The system according to claim 1, wherein the display further includes an optical influence corrector that corrects the first physical-calculation model so that a three-dimensional image displayed in the transparent portion becomes in a predetermined display state, based on attribute information of the transparent portion of the real object.

6. The system according to claim 1, wherein the real object has a scattering portion that scatters light within the transparent portion of the real object, and the display controller displays the three-dimensional image as a luminescent spot at the scattering portion of the real object.

7. The system according to claim 1, wherein the display further includes:
a position/posture detector that detects a position and posture of the real object, wherein
the position/posture detector stores the detected position and posture as real-object position/posture information, into the position/posture-information storage unit.

8. The system according to claim 7, wherein the real object further includes a sensor that can detect a position and posture, and
the position/posture detector stores the position and posture of the real object detected by the sensor as real-object position/posture information, into the position/posture-information storage unit.

9. The system according to claim 7, wherein the position/posture detector detects the position of the real object on the display surface of the three-dimensional image, by an infrared image sensor mode.

10. The system according to claim 7, wherein the real object has a light emitter that emits light,
the display further includes an imaging unit that images at least two light spots emitted from the light emitter, and
the position detector detects the position and posture of the real object, based on a positional relationship between the light spots contained in the image picked up with the imaging unit.

11. The system according to claim 9, wherein the real object has a scattering portion that scatters light at mutually different two positions of the transparent portion having a refractive index larger than one, and
the light emitter makes the scattering portion emit light through the transparent portion.

12. The system according to claim 1, wherein the display further includes:
a position displacement unit that displaces the position and posture of the real object, wherein
the position displacement unit stores the displaced position and posture of the real object as real-object position/posture information, into the position/posture-information storage unit.

13. The system according to claim 1, wherein the real object includes an information storage unit that stores attribute specific to the real object, and
the display further includes an information reading unit that reads the specific attribute from the information storage unit, and stores the specific attribute as the attribute information, into the attribute-information storage unit.

14. The system according to claim 1, wherein the real object or the display further includes a force feedback unit that generates vibration, and
the apparatus further includes a drive controller that drives the force feedback unit according to the interaction.

15. A method for displaying to a system having a display and a real object comprising:
storing position posture information expressing a position and posture of the real object to a storage unit;
storing attribute information expressing attribute of the real object to the storage unit;
generating a first physical-calculation model expressing the real object, based on the position/posture information and the attribute information;
generating a second physical-calculation model expressing a virtual external environment of the real object within a display space;
calculating interaction between the first physical-calculation model and the second physical-calculation model; and
controlling the display for displaying a three-dimensional image within the display space, based on the interaction,
wherein the display displays the three-dimensional image within the display space according to a space image mode,
the real object having at least a part of which laid out in the display space is a transparent portion.
